(19) United States
(12) Patent Application Publication
(10) Pub. No.: US 2026/0239480 A1
(43) Pub. Date: Aug. 13, 2026

(54) METHOD AND APPARATUS OF PDCCH MONITORING FOR SMALL DATA TRANSMISSION

(71) Applicant: Samsung Electronics Co., Ltd., Suwon-si (KR)

(72) Inventor: Anil AGIWAL, Suwon-si (KR)

(21) Appl. No.: 19/633,081

(22) Filed: Mar. 30, 2026

Related U.S. Application Data
(63) Continuation of application No. 17/470,476, filed on Sep. 9, 2021.

(30) Foreign Application Priority Data
Sep. 18, 2020 (KR) 10-2020-0120218

(51) Int. Cl. H04W 76/27; H04W 74/0833; H04W 74/0836; H04W 74/0838

(52) U.S. Cl. CPC H04W 76/27; H04W 74/0833; H04W 74/0836; H04W 74/0838

(57) ABSTRACT

The disclosure relates to a communication method and a system for converging a 5^{th}-Generation (5G) communication system for supporting higher data rates beyond a 4^{th}-Generation (4G) system with a technology for Internet of Things (IoT). The disclosure may be applied to intelligent services based on the 5G communication technology and the IoT-related technology, such as a smart home, a smart building, a smart city, a smart car, a connected car, health care, digital education, smart retail, security and safety services. A method and an apparatus for small data transmission are provided.

### CROSS-REFERENCE TO RELATED APPLICATION(S)

This application is a continuation application of prior application Ser. No. 17/470,476, filed on Sep. 9, 2021, which is based on and claims priority under 35 U.S.C § 119(a) of a Korean patent application number 10-2020-0120218, filed on Sep. 18, 2020, in the Ministry of Intellectual Property (MOIP), the disclosure of which is incorporated by reference herein in its entirety.

### BACKGROUND

### 1. Field

The disclosure relates to a wireless communication system. More particularly, the disclosure relates to an apparatus, a method and a system of monitoring control channel for small data transmission (SDT) in wireless communication system.

### 2. Description of Related Art

To meet the demand for wireless data traffic having increased since deployment of 4^{th} generation (4G) communication systems, efforts have been made to develop an improved 5^{th} generation (5G) or pre-5G communication system. Therefore, the 5G or pre-5G communication system is also called a ‘Beyond 4G Network’ or a ‘Post long term evolution (LTE) System’. The 5G communication system is considered to be implemented in higher frequency millimeter wave (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies, such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Meanwhile, there have been various studies on small data transmission (SD) in 5G communication system recently.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method and a system for converging a fifth generation (5G) communication system for supporting higher data rates beyond a fourth generation (4G).

Additional aspects will be set forth in part in the description which follows and, in part, will be apparent from the description, or may be learned by practice of the presented embodiments.

In accordance with an aspect of the disclosure, a method performed by a terminal is provided. The method includes receiving, from a base station, information on a search space for a small data transmission (SDT) procedure, transmitting, to the base station, a radio resource control (RRC) resume request message and uplink data, based on an initiation of the SDT procedure, receiving, from the base station, contention resolution identity information as a response to the RRC resume request message, monitoring, while the terminal is in an RRC inactive state, a physical downlink control channel (PDCCH) for subsequent transmission of the SDT procedure, the PDCCH being monitored in the search space for the SDT procedure based on the information, and identifying a termination of the SDT procedure.

In accordance with another aspect of the disclosure, a method performed by a base station is provided. The method includes transmitting, to a terminal, information on a search space for a small data transmission (SDT) procedure, receiving, from the terminal, a radio resource control (RRC) resume request message and uplink data, based on an initiation of the SDT procedure, transmitting, to the terminal, contention resolution identity information as a response to the RRC resume request message, transmitting, to the terminal while the terminal is in an RRC inactive state, a physical downlink control channel (PDCCH) for subsequent transmission of the SDT procedure, the PDCCH being transmitting in the search space for the SDT procedure based on the information, and identifying a termination of the SDT procedure.

In accordance with another aspect of the disclosure, a terminal is provided. The terminal includes a transceiver, and at least one processor configured to receive, from a base station, information on a search space for a small data transmission (SDT) procedure, transmit, to the base station, a radio resource control (RRC) resume request message and uplink data, based on an initiation of the SDT procedure, receive, from the base station, contention resolution identity information as a response to the RRC resume request message, monitor, while the terminal is in an RRC inactive state, a physical downlink control channel (PDCCH) for subsequent transmission of the SDT procedure, the PDCCH being monitored in the search space for the SDT procedure based on the information, and identify a termination of the SDT procedure.

In accordance with another aspect of the disclosure, a base station is provided. The base station includes a transceiver, and at least one processor configured to transmit, to a terminal, information on a search space for a small data transmission (SDT) procedure, receive, from the terminal, a radio resource control (RRC) resume request message and uplink data, based on an initiation of the SDT procedure, transmit, to the terminal, contention resolution identity information as a response to the RRC resume request message, transmit, to the terminal while the terminal is in an RRC inactive state, a physical downlink control channel (PDCCH) for subsequent transmission of the SDT procedure, the PDCCH being transmitting in the search space for the SDT procedure based on the information, and identify a termination of the SDT procedure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates small data transmission according to an embodiment of the disclosure;

FIG. 2 illustrates small data transmission according to an embodiment of the disclosure;

FIG. 3 illustrates small data transmission according to an embodiment of the disclosure;

FIG. 4 illustrates a flowchart for small data transmission according to an embodiment of the disclosure;

FIG. 5 illustrates a flowchart for small data transmission according to an embodiment of the disclosure;

FIG. 6 is a block diagram of a terminal according to an embodiment of the disclosure; and

FIG. 7 is a block diagram of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or next generation node B (gNB).

The “UE” is an entity communicating with a BS and may be referred to as UE, device, mobile station (MS), mobile equipment (ME), or terminal.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system is being developed to meet the growing demand for high speed data services, support ultra-reliability and low latency applications.

The fifth generation wireless communication system will be implemented not only in lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLL) etc. The eMBB requirements like tens of gigabytes per second (Gbps) data rate, low latency, high mobility so on and so forth address the market segment representing the wireless broadband subscribers of the related art needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas.

In this situation, aggregation of the plurality of antennas can be referred to as an antenna array, and each antenna included in the array can be referred to as an array element. The antenna array can be configured in various forms, such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal.

By using beamforming technique, a transmitter can make plurality of transmit beam patterns of different directions. Each of these transmit beam patterns can be also referred as TX beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of RX beam patterns of different directions. Each of these receive patterns can be also referred as RX beam.

The fifth generation wireless communication system (also referred as next generation radio or NR), supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in radio resource control connected (RRC_CONNECTED) is configured to utilize radio resources provided by two distinct schedulers, located in two different nodes connected via a non-ideal backhaul and providing either E-UTRA (Evolved Universal Mobile Telecommunications System (UMTS) Terrestrial Radio Access) (i.e., if the node is an ng-eNB) or NR access (i.e., if the node is a gNB). In NR for a UE in RRC_CONNECTED not configured with carrier aggregation (CA)/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the Primary Cell (PCell) and optionally one or more Secondary Cells (SCells). In NR the term Secondary Cell Group (SCG) refers to a group of serving cells associated with the Secondary Node, comprising of the Primary SCG Cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, SCell is a cell providing additional radio resources on top of Special Cell. PSCell refers to a serving cell in SCG in which the UE performs random access when performing the Reconfiguration with Sync procedure. For Dual Connectivity operation the term SpCell (i.e., a Special Cell) refers to the PCell of the MCG or the PSCell of the SCG, otherwise the term Special Cell refers to the PCell.

In the fifth generation wireless communication system (or NR), Physical Downlink Control Channel (PDCCH) is used to schedule downlink (DL) transmissions on Physical Downlink Shared Channel (PDSCH) and uplink (UL) transmissions on Physical Uplink Shared Channel (PUSCH), where the Downlink Control Information (DCI) on PDCCH includes: Downlink assignments containing at least modulation and coding format, resource allocation, and hybrid automatic repeat request (HARQ) information related to downlink shared channel (DL-SCH), Uplink scheduling grants containing at least modulation and coding format, resource allocation, and hybrid-ARQ information related to uplink shared channel (UL-SCH). In addition to scheduling, PDCCH can be used to for: Activation and deactivation of configured PUSCH transmission with configured grant, Activation and deactivation of PDSCH semi-persistent transmission, Notifying one or more UEs of the slot format, Notifying one or more UEs of the physical resource block(s) (PRB(s)) and orthogonal frequency division multiplexing (OFDM) symbol(s) where the UE may assume no transmission is intended for the UE, Transmission of transmission power control (TPC) commands for physical uplink control channel (PUCCH) and PUSCH, Transmission of one or more TPC commands for sounding reference signal (SRS) transmissions by one or more UEs, Switching a UE's active bandwidth part, Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In NR, a list of search space configurations are signaled by gNB for each configured bandwidth part (BWP) wherein each search configuration is uniquely identified by an identifier. Identifier of search space configuration to be used for specific purpose, such as paging reception, system information (SI) reception, random access response (RAR) reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the Equation 1 below:

$$( y * ( number of slots in a radio frame ) + x - Monitoring - offset - PDCCH - slot ) mod ( Monitoring - periodicity - PDCCH - slot ) - 0 ; \qquad Equation 1$$

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of CORESET configuration associated with it. A list of CORESET configurations are signaled by gNB for each configured BWP wherein each CORESET configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported subcarrier spacing (SCS) is pre-defined in NR. Each CORESET configuration is associated with a list of TCI (Transmission configuration indicator) states. One DL reference signal (RS) identifier (ID) (SSB or channel state information reference signal (CSI-RS)) is configured per TCI state. The list of TCI states corresponding to a CORESET configuration is signaled by gNB via RRC signaling. One of the TCI state in TCI state list is activated and indicated to the UE by gNB. TCI state indicates the DL TX beam (DL TX beam is quasi-collocated (QCLed) with SSB/CSI RS of TCI state) used by GNB for transmission of PDCCH in the PDCCH monitoring occasions of a search space.

In NR bandwidth adaptation (BA) is supported. With BA, the receive and transmit bandwidth of a UE need not be as large as the bandwidth of the cell and can be adjusted: the width can be ordered to change (e.g., to shrink during period of low activity to save power), the location can move in the frequency domain (e.g., to increase scheduling flexibility), and the subcarrier spacing can be ordered to change (e.g., to allow different services). A subset of the total cell bandwidth of a cell is referred to as a Bandwidth Part (BWP).

BA is achieved by configuring RRC connected UE with BWP(s) and telling the UE which of the configured BWPs is currently the active one. When BA is configured, the UE only has to monitor PDCCH on the one active BWP, i.e., it does not have to monitor PDCCH on the entire DL frequency of the serving cell. In RRC connected state, the UE is configured with one or more DL and UL BWPs, for each configured Serving Cell (i.e., a PCell or a SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the medium access control (MAC) entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer, the UE switches to the active DL BWP to the default DL BWP or initial DL BWP (if default DL BWP is not configured).

In the 5G wireless communication system, random access (RA) is supported. Random access (RA) is used to achieve uplink (UL) time synchronization. RA is used during initial access, handover, RRC connection re-establishment procedure, scheduling request transmission, SCG addition/modification, beam failure recovery and data or control information transmission in UL by non-synchronized UE in RRC CONNECTED state. Several types of random access procedure is supported.

Contention based random access (CBRA): This is also referred as 4 step CBRA. In this type of random access, the UE first transmits Random Access preamble (also referred as Msg1) and then waits for Random access response (RAR) in the RAR window. RAR is also referred as Msg2. Next generation node B (gNB) transmits the RAR on PDSCH. PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., RA preamble, 0≤s_id<14, t_id is the index of the first slot of the PRACH occasion (0≤t_id<80), f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random access preambles detected by gNB can be multiplexed in the same RAR MAC protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and the UE has not yet transmitted the RA preamble for a configurable (configured by gNB in RACH configuration) number of times, the UE goes back to first step i.e., select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message, such as RRC connection request, RRC connection re-establishment request, RRC handover confirm, scheduling request, SI request etc. It may include the UE identity (i.e., cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a PDCCH addressed to C-RNTI included in Msg3, contention resolution is considered successful, contention resolution timer is stopped and RA procedure is completed. While the contention resolution timer is running, if the UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and the UE has not yet transmitted the RA preamble for a configurable number of times, the UE goes back to first step i.e., select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios, such as handover where low latency is required, timing advance establishment for SCell, etc. Evolved node B (eNB) assigns to the UE dedicated Random access preamble. UE transmits the dedicated RA preamble. The ENB transmits the RAR on PDSCH addressed to RA-RNTI. RAR conveys RA preamble identifier and timing alignment information. RAR may also include UL grant. RAR is transmitted in RAR window similar to CBRA procedure. CFRA is considered successfully completed after receiving the RAR including RAPID of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and the UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access i.e., during random access resource selection for Msg1 transmission, the UE determines whether to transmit dedicated preamble or non-dedicated preamble. Dedicated preambles is typically provided for a subset of SSBs/CSI-RSs. If there is no SSB/CSI-RS having DL reference signal received power (RSRP) above a threshold amongst the SSBs/CSI-RSs for which contention free random access resources (i.e., dedicated preambles/ROs) are provided by gNB, the UE select non-dedicated preamble. Otherwise, the UE select dedicated preamble. So during the RA procedure, one random access attempt can be CFRA while other random access attempt can be CBRA.

2 step contention based random access (2 step CBRA): In the first step, the UE transmits random access preamble on PRACH and a payload (i.e., a MAC PDU) on PUSCH. The random access preamble and payload transmission is also referred as MsgA. In the second step, after MsgA transmission, the UE monitors for a response from the network (i.e., a gNB) within a configured window. The response is also referred as MsgB. If CCCH SDU was transmitted in MsgA payload, the UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if the UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, the UE transmits Msg3 and performs contention resolution using Msg4 as in CBRA procedure. If contention resolution is successful, random access procedure is considered successfully completed. If contention resolution fails upon fallback (i.e., upon transmitting Msg3), the UE retransmits MsgA. If configured window in which the UE monitors network response after transmitting MsgA expires and the UE has not received MsgB including contention resolution information or fallback information as explained above, the UE retransmits MsgA. If the random access procedure is not successfully completed even after transmitting the MsgA configurable number of times, the UE fallbacks to 4 step RACH procedure, i.e., the UE only transmits the PRACH preamble.

MsgA payload may include one or more of CCCH SDU, dedicated control channel (DCCH) SDU, dedicated traffic channel (DTCH) SDU, buffer status report (BSR) MAC CE, power headroom report (PHR) MAC CE, SSB information, C-RNTI MAC CE, or padding. MsgA may include a UE ID (e.g., a random ID, S-TMSI, C-RNTI, resume ID, or the like) along with preamble in first step. The UE ID may be included in the MAC PDU of the MsgA. The UE ID, such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which the UE performs the RA procedure. When the UE performs RA after power on (before it is attached to the network), then the UE ID is the random ID. When the UE perform RA in IDLE state after it is attached to network, the UE ID is S-TMSI. If the UE has an assigned C-RNTI (e.g., in connected state), the UE ID is C-RNTI. In case the UE is in INACTIVE state, the UE ID is resume ID. In addition to the UE ID, some addition ctrl information can be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case the gNB assigns to the UE dedicated Random access preamble(s) and PUSCH resource(s) for MsgA transmission. RO(s) to be used for preamble transmission may also be indicated. In the first step, the UE transmits random access preamble on PRACH and a payload on PUSCH using the contention free random access resources (i.e., a dedicated preamble/PUSCH resource/RO). In the second step, after MsgA transmission, the UE monitors for a response from the network (i.e., a gNB) within a configured window. If the UE receives PDCCH addressed to C-RNTI, random access procedure is considered successfully completed. If the UE receives fallback information corresponding to its transmitted preamble, random access procedure is considered successfully completed.

For certain events such has handover and beam failure recovery if dedicated preamble(s) and PUSCH resource(s) are assigned to the UE, during first step of random access, i.e., during random access resource selection for MsgA transmission UE determines whether to transmit dedicated preamble or non-dedicated preamble. Dedicated preambles is typically provided for a subset of SSBs/CSI-RSs. If there is no SSB/CSI-RS having DL RSRP above a threshold amongst the SSBs/CSI-RSs for which contention free random access resources (i.e., dedicated preambles/ROs/PUSCH resources) are provided by gNB, the UE select non dedicated preamble. Otherwise, the UE select dedicated preamble. So during the RA procedure, one random access attempt can be 2 step CFRA while other random access attempt can be 2 step CBRA.

Upon initiation of random access procedure, the UE first selects the carrier (SUL or NUL). If the carrier to use for the Random Access procedure is explicitly signaled by the gNB, the UE select the signaled carrier for performing Random Access procedure. If the carrier to use for the Random Access procedure is not explicitly signaled by gNB, and if the Serving Cell for the Random Access procedure is configured with supplementary uplink and if the RSRP of the downlink pathloss reference is less than rsrp-ThresholdSSB-SUL: the UE selects the SUL carrier for performing Random Access procedure. Otherwise, the UE selects the NUL carrier for performing Random Access procedure. Upon selecting the UL carrier, the UE determines the UL and DL BWP for random access procedure as specified in section 5.15 of TS 38.321. Thereafter, the UE determines whether to perform 2 step or 4 step RACH for this random access procedure.
If this random access procedure is initiated by PDCCH order and if the ra-PreambleIndex explicitly provided by PDCCH is not 0b000000, the UE selects 4 step RACH.
else if 2 step contention free random access resources are signaled by gNB for this random access procedure, the UE selects 2 step RACH.
else if 4 step contention free random access resources are signaled by gNB for this random access procedure, the UE selects 4 step RACH.
else if the UL BWP selected for this random access procedure is configured with only 2 step RACH resources, the UE selects 2 step RACH.
else if the UL BWP selected for this random access procedure is configured with only 4 step RACH resources, the UE selects 4 step RACH.
else if the UL BWP selected for this random access procedure is configured with both 2 step and 4 step RACH resources,
if RSRP of the downlink pathloss reference is below a configured threshold, the UE selects 4 step RACH. Otherwise, the UE selects 2 step RACH.

In the fifth generation wireless communication system, the RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e., no RRC connection is established, the UE is in RRC_IDLE state. The RRC states can further be characterized as follows:

In the RRC_IDLE, a UE specific discontinuous (DRX) may be configured by upper layers. The UE monitors Short Messages transmitted with paging RNTI (P-RNTI) over DCI, monitors a Paging channel for CN paging using 5G-S-temporary mobile subscriber identity (5G-S-TMSI), performs neighboring cell measurements and cell (re-)selection, acquires system information and can send SI request (if configured), performs logging of available measurements together with location and time for logged measurement configured UEs.

In RRC_INACTIVE, a UE specific DRX may be configured by upper layers or by RRC layer, the UE stores the UE Inactive AS context, a RAN-based notification area is configured by RRC layer. The UE monitors Short Messages transmitted with P-RNTI over DCI, monitors a Paging channel for CN paging using 5G-S-TMSI and RAN paging using fullI-RNTI, performs neighboring cell measurements and cell (re-)selection, performs RAN-based notification area updates periodically and when moving outside the configured RAN-based notification area; acquires system information and can send SI request (if configured), performs logging of available measurements together with location and time for logged measurement configured UEs.

In the RRC_CONNECTED, the UE stores the AS context and transfer of unicast data to/from the UE takes place. The UE monitors Short Messages transmitted with P-RNTI over DCI, if configured, monitors control channels associated with the shared data channel to determine if data is scheduled for it, provides channel quality and feedback information, performs neighboring cell measurements and measurement reporting, acquires system information.

In the RRC_CONNECTED, network may initiate suspension of the RRC connection by sending RRCRelease with suspend configuration. When the RRC connection is suspended, the UE stores the UE Inactive AS context and any configuration received from the network, and transits to RRC_INACTIVE state. If the UE is configured with SCG, the UE releases the SCG configuration upon initiating a RRC Connection Resume procedure. The RRC message to suspend the RRC connection is integrity protected and ciphered.

The resumption of a suspended RRC connection is initiated by upper layers when the UE needs to transit from RRC_INACTIVE state to RRC_CONNECTED state or by RRC layer to perform a RAN based notification area (RNA) update or by RAN paging from NG-RAN. When the RRC connection is resumed, network configures the UE according to the RRC connection resume procedure based on the stored UE Inactive AS context and any RRC configuration received from the network. The RRC connection resume procedure re-activates AS security and re-establishes signaling radio bearer(s) (SRB(s)) and data radio bearer(s) (DRB(s)). In response to a request to resume the RRC connection, the network may resume the suspended RRC connection and send UE to RRC_CONNECTED, or reject the request to resume and send UE to RRC_INACTIVE (with a wait timer), or directly re-suspend the RRC connection and send UE to RRC_INACTIVE, or directly release the RRC connection and send UE to RRC_IDLE, or instruct the UE to initiate NAS level recovery (in this case the network sends an RRC setup message).

Upon initiating the resume procedure, UE:
apply the default L1 parameter values as specified in corresponding physical layer specifications, except for the parameters for which values are provided in SIB1;
apply the default MAC Cell Group configuration
apply the CCCH configuration
start timer T319;
apply the timeAlignmentTimerCommon included in SIB1
apply the default SRB1 configuration
set the variable pendingRNA-Update to false;
initiate transmission of the RRCResumeRequest message or RRCResumeRequest1
restore the RRC configuration, RoHC state, the stored QoS flow to DRB mapping rules and the KgNB and K_{RRCint} keys from the stored UE Inactive AS context except for the following:
   masterCellGroup;
   mrdc-SecondaryCellGroup, if stored; and
   pdcp-Config;
set the resumeMAC-I to the 16 least significant bits of the MAC-I calculated:
   with the K_{RRCint} key in the UE Inactive AS Context and the previously configured integrity protection algorithm; and
   with all input bits for COUNT, BEARER and DIRECTION set to binary ones;
derive the KgNB key based on the current KgNB key or the NH, using the stored nextHopChainingCount value;
derive the K_{RRCenc} key, the K_{RRCint} key, the K_{UPint} key and the K_{UPenc} key;
configure lower layers to apply integrity protection for all signaling radio bearers except SRB0 using the configured algorithm and the K_{RRCint} key and K_{UPint} key, i.e., integrity protection shall be applied to all subsequent messages received and sent by the UE;
configure lower layers to apply ciphering for all signaling radio bearers except SRB0 and to apply the configured ciphering algorithm, the K_{RRCenc} key and the K_{UPenc} key derived, i.e., the ciphering configuration shall be applied to all subsequent messages received and sent by the UE;
re-establish PDCP entities for SRB1;
resume SRB1;
transmit RRCResumeRequest or RRCResumeRequest1.

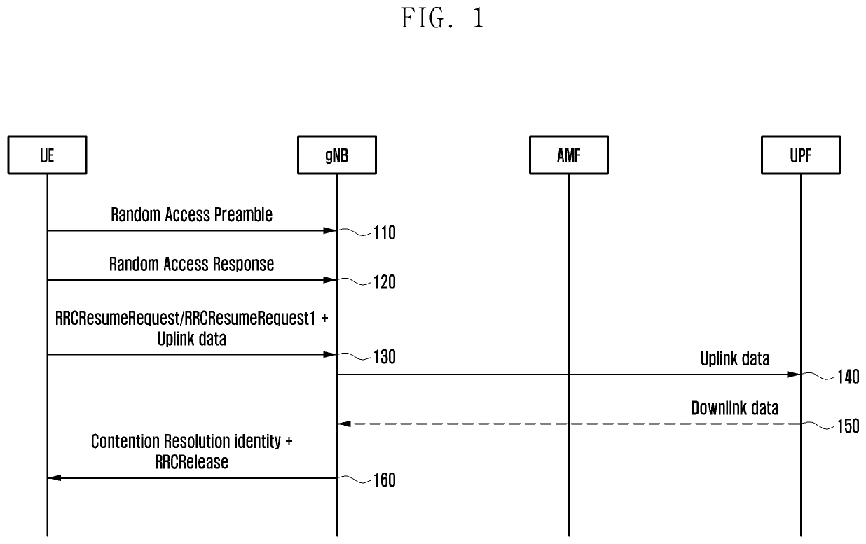

In 5G wireless communication system, small data transmission (SDT) in RRC_INACTIVE is supported. The uplink data can be transmitted in Msg3 in 4 step RA procedure, and can be transmitted in MsgA in 2 step RA procedure. FIG. 1 is an example signaling flow for small data transmission using 4 step RA.

FIG. 1 illustrates small data transmission according to an embodiment of the disclosure.

Referring to FIG. 1, criteria to initiate 4 step RA for SDT is met. The UE select preamble/RO from preambles/ROs for SDT. The UE transmits random access preamble and receives RAR including UL grant for Msg3 transmission in operations 110, 120.

The UE sends an RRCResumeRequest/RRCResumeRequest1 to the gNB (same as the last serving GNB) on SRB 0 in operation 130. It includes full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA (NR integrity algorithm) or EIA (EPS integrity algorithm)) in the stored AS security context, which was negotiated between the UE and the last serving gNB and the K_{RRCint} from the stored AS security context with the following inputs:
KEY: it shall be set to K_{RRCint} from the stored AS security context;
BEARER: all its bits shall be set to 1.
DIRECTION: its bit shall be set to 1;
COUNT: all its bits shall be set to 1;
MESSAGE: it shall be set to VarResumeMAC-Input with following inputs:
   source physical cell identity (PCI) (set to the physical cell identity of the PCell the UE was connected to prior to suspension of the RRC connection)
   target Cell-ID (Set to the cellIdentity of the first PLMN-Identity included in the PLMN-IdentityInfoList broadcasted in SIB1 of the target cell, i.e., the cell to which the UE is sending small data)
   source C-RNTI (Set to C-RNTI that the UE had in the PCell it was connected to prior to suspension of the RRC connection).

The UE resumes SRB0 and SRB1. The UE resumes DRB(s), derives new security keys using the NextHopChainingCount provided in the RRCRelease message of the previous RRC connection and re-establishes the AS security, i.e., derive the KgNB key based on the KgNB key or the NH, using the stored nextHopChainingCount value, derive the K_{RRCenc} key, the K_{RRCint} key, the K_{UPint} key and the K_{UPenc} key, configure lower layers to apply integrity protection for all signaling radio bearers except SRB0 using the configured algorithm and the K_{RRCint} key and K_{UPint} key, i.e., integrity protection shall be applied to all subsequent messages received and sent by the UE, configure lower layers to apply ciphering for all signaling radio bearers except SRB0 and to apply the configured ciphering algorithm, the K_{RRCenc} key and the K_{UPenc} key derived, i.e., the ciphering configuration shall be applied to all subsequent messages received and sent by the UE. The user data are ciphered and integrity protected (Only for DRBs configured with UP integrity protection) and transmitted on DTCH multiplexed with the RRCResumeRequest/RRCResumeRequest1 message on CCCH/CCCH1.

The GNB validates the resumeMAC-I and delivers the uplink data to UPF in operation 140.

The gNB sends the RRCRelease message to keep the UE in RRC_INACTIVE. PDCCH is addressed to temporary C-RNTI (TC-RNTI). If downlink data is available, they are sent ciphered and integrity protected (Only for DRBs configured with UP integrity protection) on DTCH multiplexed with the RRCRelease message on DCCH in operations 150, 160. In an embodiment of the disclosure, upon termination/completion of SDT procedure upon receiving RRCRelease message, the UE stores the K_{RRCint} key (i.e., a key which is derived during the initiation of SDT procedure) in AS context. The UE also stores the NCC received (e.g., in RRCRelease message) during the SDT procedure, the UE may also store the PCI of camped cell as source PCI in stored AS context, the UE also stores the C-RNTI used during the SDT procedure in stored AS context.

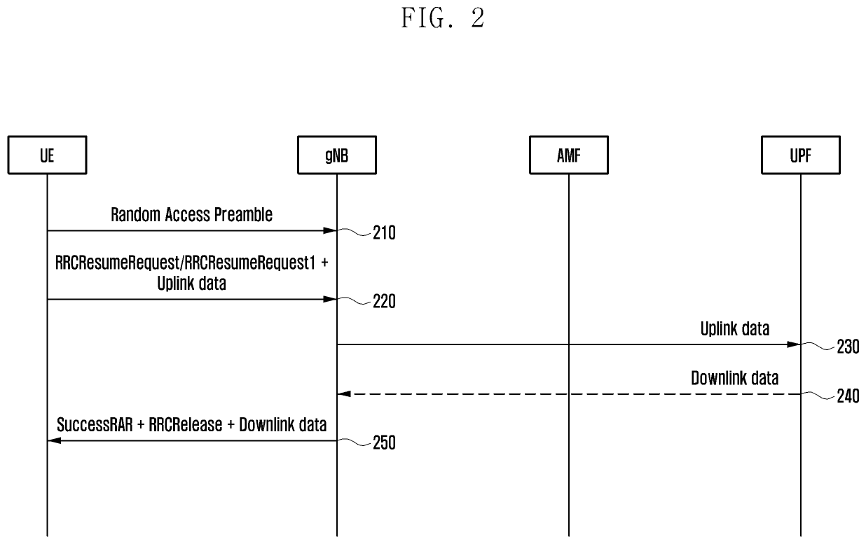

FIG. 2 shows small data transmission using 2 step RA.

FIG. 2 illustrates small data transmission according to an embodiment of the disclosure.

Referring to FIG. 2, criteria to initiate 2 step RA for SDT is met. The UE select preamble/RO/PO from preambles/ROs/POs for SDT. The UE transmits random access preamble in operation 210.

In the MsgA payload, the UE sends an RRCResumeRequest/RRCResumeRequest1 to the gNB (same as the last serving GNB) on SRB 0 in operation 220. It includes full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA or EIA) in the stored AS security context, which was negotiated between the UE and the last serving gNB and the K_{RRCint} from the stored AS security context with the following inputs:
KEY: it shall be set to K_{RRCint} from the stored AS security context;
BEARER: all its bits shall be set to 1.
DIRECTION: its bit shall be set to 1;
COUNT: all its bits shall be set to 1;
MESSAGE: it shall be set to VarResumeMAC-Input with following inputs:
   source PCI (set to the physical cell identity of the PCell the UE was connected to prior to suspension of the RRC connection)
   target Cell-ID (Set to the cellIdentity of the first PLMN-Identity included in the PLMN-IdentityInfoList broadcasted in SIB1 of the target cell, i.e., the cell to which the UE is sending small data)
   source C-RNTI (Set to C-RNTI that the UE had in the PCell it was connected to prior to suspension of the RRC connection).

The UE resumes SRB0 and SRB1. The UE resumes DRB(s), derives new security keys using the NextHopChainingCount provided in the RRCRelease message of the previous RRC connection and re-establishes the AS security, i.e., derive the KgNB key based on the KgNB key or the NH, using the stored nextHopChainingCount value, derive the K_{RRCenc} key, the K_{RRCint} key, the K_{UPint} key and the K_{UPenc} key, configure lower layers to apply integrity protection for all signaling radio bearers except SRB0 using the configured algorithm and the K_{RRCint} key and K_{UPint} key, i.e., integrity protection shall be applied to all subsequent messages received and sent by the UE, configure lower layers to apply ciphering for all signaling radio bearers except SRB0 and to apply the configured ciphering algorithm, the K_{RRCenc} key and the K_{UPenc} key derived, i.e., the ciphering configuration shall be applied to all subsequent messages received and sent by the UE. The user data are ciphered and integrity protected (Only for DRBs configured with UP integrity protection) and transmitted on DTCH multiplexed with the RRCResumeRequest/RRCResumeRequest1 message on CCCH/CCCH1.

The GNB validates the resumeMAC-I and delivers the uplink data to UPF in operation 230.

3. The gNB sends the RRCRelease message to keep the UE in RRC_INACTIVE in MsgB along with successRAR. PDCCH is addressed to C-RNTI. If downlink data is available, they are sent ciphered and integrity protected (Only for DRBs configured with UP integrity protection) on DTCH multiplexed with the RRCRelease message on DCCH in operations 240, 250. In an embodiment of the disclosure, upon termination/completion of SDT procedure upon receiving an RRCRelease message, the UE stores the K_{RRCint} key (i.e., a key which is derived during the initiation of SDT procedure) in AS context. The UE also stores the NCC received (e.g., in a RRCRelease message) during the SDT procedure, the UE may also store the PCI of camped cell as source PCI in stored AS context, the UE also stores the C-RNTI used during the SDT procedure in stored AS context.

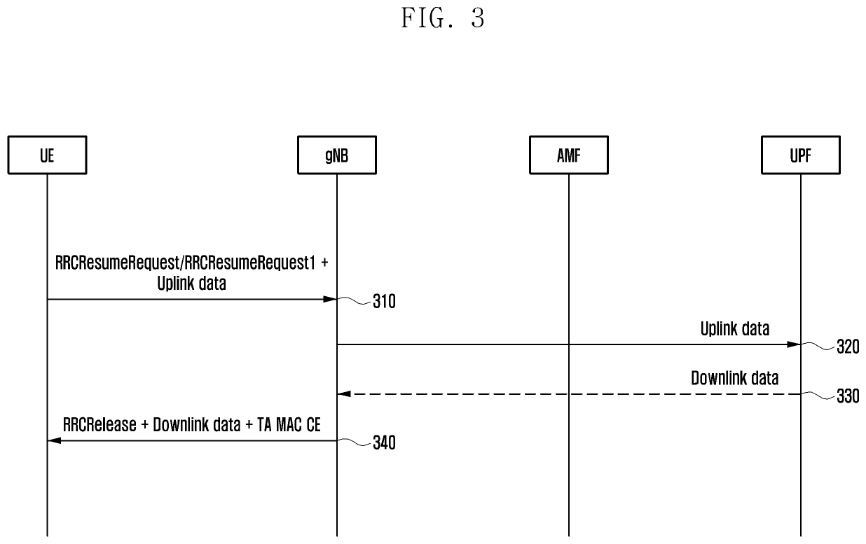

FIG. 3 illustrates small data transmission using preconfigured PUSCH resource.

FIG. 3 illustrates small data transmission according to an embodiment of the disclosure.

Referring to FIG. 3, criteria to initiate SDT using preconfigured PUSCH resources is met.

In the preconfigured PUSCH resource, the UE sends an RRCResumeRequest/RRCResumeRequest1 to the gNB (same as the last serving GNB) on SRB 0 in operation 310. It includes full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA or EIA) in the stored AS security context, which was negotiated between the UE and the last serving gNB and the K_{RRCint} from the stored AS security context with the following inputs:
KEY: it shall be set to K_{RRCint} from the stored AS security context;
BEARER: all its bits shall be set to 1.
DIRECTION: its bit shall be set to 1;
COUNT: all its bits shall be set to 1;
MESSAGE: it shall be set to VarResumeMAC-Input with following inputs:
   source PCI (set to the physical cell identity of the PCell the UE was connected to prior to suspension of the RRC connection)
   target Cell-ID (Set to the cellIdentity of the first PLMN-Identity included in the PLMN-IdentityInfoList broadcasted in SIB1 of the target cell, i.e., the cell to which the UE is sending small data)
   source C-RNTI (Set to C-RNTI that the UE had in the PCell it was connected to prior to suspension of the RRC connection).

The UE resumes SRB0 and SRB1. The UE resumes DRB(s), derives new security keys using the NextHopChainingCount provided in the RRCRelease message of the previous RRC connection and re-establishes the AS security, i.e., derive the KgNB key based on the KgNB key or the NH, using the stored nextHopChainingCount value, derive the K_{RRCenc} key, the K_{RRCint} key, the K_{UPint} key and the K_{UPenc} key, configure lower layers to apply integrity protection for all signaling radio bearers except SRB0 using the configured algorithm and the K_{RRCint} key and K_{UPint} key, i.e., integrity protection shall be applied to all subsequent messages received and sent by the UE, configure lower layers to apply ciphering for all signaling radio bearers except SRB0 and to apply the configured ciphering algorithm, the K_{RRCenc} key and the K_{UPenc} key derived, i.e., the ciphering configuration shall be applied to all subsequent messages received and sent by the UE. The user data are ciphered and integrity protected (Only for DRBs configured with UP integrity protection) and transmitted on DTCH multiplexed with the RRCResumeRequest/RRCResumeRequest1 message on CCCH.

The UE can alternately transmits its small data by using one of the following options:
RRCResumeRequest (or new RRC message). ResumeIdentity, ResumeMAC-I, resumeCause, NAS container in RRCResumeRequest/RRCResumeRequest1. NAS container includes UL data.
new MAC CE (resumeIdentity, ResumeMAC-I)+uplink data (on DTCH). ResumeIdentity is provided for UE identification purpose. ResumeMAC-I is for security

The gNB validates the resumeMAC-I and delivers the uplink data to UPF in operation 320.

The gNB sends the RRCRelease message to keep the UE in RRC_INACTIVE. The PDCCH is addressed to C-RNTI. The C-RNTI is the one which the UE used in cell from which it received preconfigured PUSCH resources. Alternately, the C-RNTI can be assigned along with preconfigured PUSCH resources. If downlink data is available, they are sent ciphered and integrity protected (Only for DRBs configured with UP integrity protection) on DTCH multiplexed with the RRCRelease message on DCCH in operations 330, 340. In an embodiment of the disclosure, upon termination/completion of SDT procedure upon receiving RRCRelease message, the UE stores the K_{RRCint} key (i.e., a key which is derived during the initiation of SDT procedure) in AS context. The UE also stores the NCC received (e.g., in a RRCRelease message) during the SDT procedure, the UE may also store the PCI of camped cell as source PCI in stored AS context, the UE also stores the C-RNTI used during the SDT procedure in stored AS context.

(Alternate 1) We can consider an alternate signaling flow wherein gNB can schedule UL grant (PDCCH addressed to C-RNTI) before RRCRelease. In the UL transmission UE can indicate if it has more data to transmit. If the UE has more data to transmit, gNB can schedule UL grant. Otherwise RRCRelease is transmitted. In the UL transmission, the UE can also include SSB ID(s) of SSB above threshold if the SSB indicated by PRACH preamble is no longer suitable.

(Alternate 2) Alternately, the gNB can transmit PDCCH addressed to RNTI (i.e., RNTI is the one assigned by gNB along with preconfigured resource, it can be assigned to other UEs as well) and scheduled DL transport block (TB) includes contention resolution identity (it is first X bits (e.g., 48 bits) of resume message) and C-RNTI. If it matches with UE's contention resolution identity, the UE stops the monitoring timer and the UE can consider small data transmission as successful.

In the response of the small data transmission, the UE can receive a signal (RRC message or DCI) for the following purpose: releasing pre-configured PUSCH or switching to resume procedure (i.e., RRC_CONNECTED).

In case of 4 step RA initiated for SDT, after receiving Msg3, gNB sends contention resolution identity and subsequently schedule resources for DL/UL transmission by sending PDCCH addressed to C-RNTI. RA procedure is completed in the UE upon receiving the contention resolution identity and the UE promotes the TC-RNTI received in RAR to C-RNTI. The UE continues monitoring PDCCH addressed to C-RNTI. Note that the UE is still in RRC_INACTIVE and SDT procedure is not terminated as gNB has not yet completed this procedure by sending RRCRelease message or MAC CE/DCI indicating termination of SDT.

In case of 2 step RA initiated for SDT, after receiving MsgA (i.e., both preamble and MsgA payload), gNB sends successRAR and subsequently schedule resources for DL/UL transmission by sending PDCCH addressed to C-RNTI. RA procedure is completed in the UE upon receiving the successRAR UE continues monitoring PDCCH addressed to C-RNTI received in successRAR. Note that the UE is still in RRC_INACTIVE and SDT procedure is not terminated as gNB has not yet completed this procedure by sending RRCRelease message or MAC CE/DCI indicating termination of SDT.

In case of 2 step RA initiated for SDT, after receiving MsgA (i.e., only preamble), gNB sends fallbackRAR. The UE transmits Msg3. After receiving Msg3, gNB sends contention resolution identity and subsequently schedule resources for DL/UL transmission by sending PDCCH addressed to C-RNTI. RA procedure is completed in the UE upon receiving the contention resolution identity and the UE promotes the TC-RNTI received in fallbackRAR to C-RNTI. The UE continues monitoring PDCCH addressed to C-RNTI. Note that the UE is still in RRC_INACTIVE and SDT procedure is not terminated as gNB has not yet completed this procedure by sending RRCRelease message or MAC CE/DCI indicating termination of SDT.

In case of preconfigured resource based SDT, after transmitting Uplink data in preconfigured PUSCH resources, the UE monitors C-RNTI. The UE can monitor PDCCH addressed to C-RNTI where the C-RNTI is the one which the UE used in cell from which it received preconfigured PUSCH resources. Alternately, the C-RNTI can be assigned along with preconfigured PUSCH resources (e.g., in RRCRelease message). gNB can schedule resources for DL/UL transmissions by sending PDCCH addressed to C-RNTI.

The issue is in which the search space UE monitors PDCCH addressed to C-RNTI while in RRC_INACTIVE state for subsequent DL/UL transmissions. Currently, the UE monitors PDCCH addressed to C-RNTI in following search spaces: One or more search spaces indicated in PDCCH-Config IE with searchSpaceType=common, One or more search spaces indicated in PDCCH-Config IE with searchSpaceType=UE-specific. These search spaces indicated in PDCCH-Config IE cannot be used as these are configured in RRCReconfiguration message and are available in RRC Connected.

According to the standard, the UE also monitors PDCCH addressed to C-RNTI in slots where the UE monitors SI-RNTI, RA-RNTI, MsgB-RNTI and P-RNTI. The UE monitors RA-RNTI, MsgB-RNTI in RAR response window and MsgB response window respectively during the random access procedure. After random access procedure is completed, the UE does not monitor RA-RNTI, MsgB-RNTI. The UE monitors P-RNTI only in its PO, i.e., once per DRX cycle. The UE monitors SI-RNTI only when SI acquisition is needed. So enhancement is needed to address PDCCH monitoring for subsequent UL/DL transmission in inactive state.

Another issue for PDCCH monitoring is that, the UE needs to know SSB to which the PDCCH transmission/reception is QCLed with for subsequent DL/UL transmissions in RRC_INACTIVE upon completion of RA procedure for SDT. Handling of SSB change also needs to be addressed

### Embodiment 1—PDCCH Monitoring for Subsequent DL/UL Transmission During SDT Procedure in RRC_INACTIVE

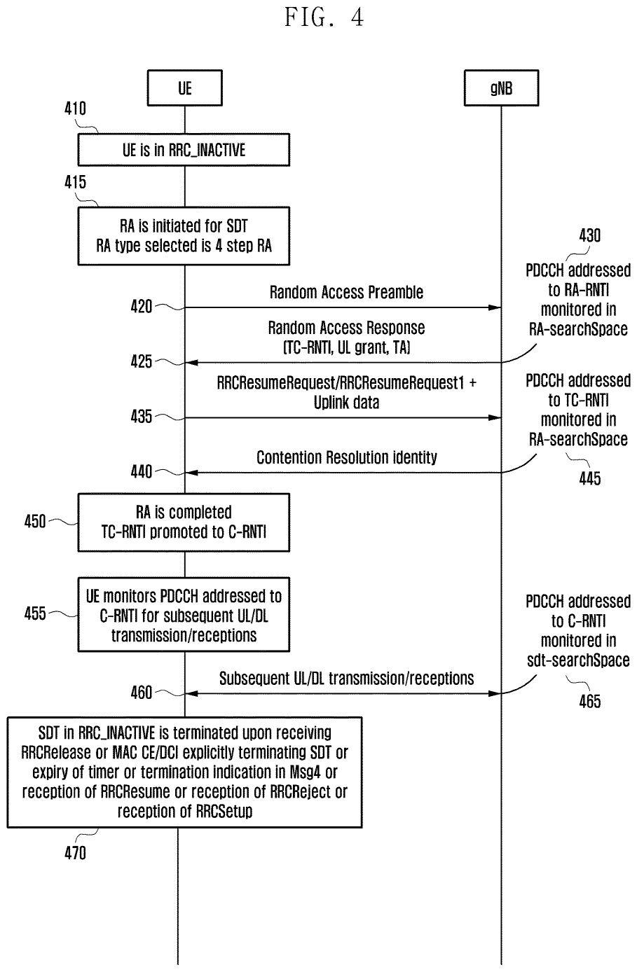

FIG. 4 illustrates a flowchart for small data transmission according to an embodiment of the disclosure.

FIG. 4 is an example signaling flow between the UE and the gNB for SDT using 4 step RA.

Referring to FIG. 4, the UE is in RRC_INACTIVE state in operation 410.

The UE initiate RA for SDT when the criteria to initiate SDT is met. The UE starts a timer for SDT. The value of timer is configured/signaled by gNB in system information of camped cell or in RRCRelease message or in RRCReconfiguration message. If not signaled, the UE can use default value of timer for SDT.

For RA initiated for SDT, the UE selects 4 step RA in operation 415 in this embodiment. Criteria to perform SDT and RA type selection for SDT is detailed later in the description.

The UE select an SSB. If there is at least one SSB available whose SS-RSRP is above a configured threshold (signaled by gNB in system information), the UE select SSB whose SS-RSRP is above a configured threshold. Otherwise, the UE select any SSB. The UE select preamble/RO corresponding to selected SSB from preambles/ROs for SDT. The UE transmits random access preamble and receives RAR including UL grant for Msg3 transmission in operations 420, 425. RAR also includes TA and TC-RNTI. For RAR, the UE monitors PDCCH addressed to RA-RNTI in RAR window. The PDCCH monitoring occasions monitored by the UE within the RAR window are indicated by search space parameters identified by ra-search space in operation 430. Multiple sets of search space parameters are signaled by camped on cell in system information. Each set is identified by search space ID. The parameter ra-search space indicate the search space ID of set of search space parameters to be used for monitoring PDCCH addressed to RA-RNTI in RAR window. The RA-RNTI is calculated as follows: RA-RNTI=1+s_id+14*t_id+14*80*f_id+14*80*8*ul_carrier_id, where s_id is the index of the first OFDM symbol of the PRACH occasion where the UE has transmitted Msg1, i.e., RA preamble, 0≤s_id<14 , t_id is the index of the first slot of the PRACH occasion (0≤t_id<80), f_id is the index of the PRACH occasion within the slot in the frequency domain (0≤f_id<8), and ul_carrier_id is the UL carrier used for Msg1 transmission (0 for NUL carrier and 1 for SUL carrier.

The UE applies the received TA and start time alignment timer. The UE transmit Msg3 in UL grant received in RAR in operation 435. Msg3 Payload can be generated using one of the following ways:

Option 1:

In the Msg3 payload, the UE sends an RRCResumeRequest/RRCResumeRequest 1 to the gNB on SRB 0. It includes full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA or EIA) in the stored AS security context, which was negotiated between the UE and the last serving gNB and the K_{RRCint} from the stored AS security context with the following inputs:
KEY: it shall be set to current K_{RRCint};
BEARER: all its bits shall be set to 1.
DIRECTION: its bit shall be set to 1;
COUNT: all its bits shall be set to 1;
MESSAGE: it shall be set to VarResumeMAC-Input with following inputs:
   source PCI (set to the physical cell identity of the PCell the UE was connected to prior to suspension of the RRC connection)
   target Cell-ID (Set to the cellIdentity of the first PLMN-Identity included in the PLMN-IdentityInfoList broadcasted in SIB1 of the target cell, i.e., the cell to which the UE is sending small data)
   source C-RNTI (Set to C-RNTI that the UE had in the PCell it was connected to prior to suspension of the RRC connection).

The UE resumes SRB(s) and DRB(s). Instead of resuming all DRBs and re-establishing PDCP (packet data convergence protocol)/RLC entities for all DRBs in the above operation, the UE resumes and re-establishes (PDCP entity and RLC entity) only those DRBs for which small data transmission is allowed. The UE resumes SRB0 and SRB1. The UE resumes and re-establishes (PDCP entity and RLC entity) of SRB2 only if small data transmission is allowed for SRB2.

The DRBs for which small data transmission is allowed can be signaled by gNB (e.g., in RRCRelease message or any other RRC signaling message). One or more DRB identities of DRBs for which small data transmission is allowed can be included in RRCRelease message.

The UE derives new security keys using the NextHopChainingCount provided in the RRCRelease message of the previous RRC connection and re-establishes the AS security. The user data are ciphered and integrity protected (Only for DRBs configured with UP integrity protection) and transmitted on DTCH multiplexed with the RRCResumeRequest/RRCResumeRequest1 message on CCCH/CCCH1 respectively. Note that depending on size of UL grant, DTCH may or may not be multiplexed with CCCH/CCCH1. Uplink data size may also be included wherein a new MAC CE or BSR MAC CE is included in Msg3.

In an embodiment of the disclosure, if UE's current serving cell is same as the PCell where the UE was connected to prior to suspension of the RRC connection, or if UE's current serving cell belongs to the same gNB as the gNB of the PCell where UE was connected to prior to suspension of the RRC connection, or if the UE's current serving cell is same as the PCell where the UE was connected to prior to suspension of the RRC connection and integrity protection is enabled for the DRB which triggered small data transmission, or if the UE's current serving cell belongs to the same gNB as the gNB of the PCell where UE was connected to prior to suspension of the RRC connection and integrity protection is enabled for the DRB which triggered small data transmission, the UE does not derive new security keys. The UE uses the security keys in stored AS context for protection of SRBs and DRBs.

If security key in stored AS context is used, security parameters (BEARER, DIRECTION, COUNT) and security key will be same for packet transmitted when RRC connected and packet transmitted for SDT. Similarly, when the UE derives new security keys using the NextHopChainingCount upon initiation of SDT procedure in the camped cell after the termination of a previously initiated SDT procedure, security parameters (BEARER, DIRECTION, COUNT) and security key will be same for packet transmitted for SDT during this SDT procedure and packet transmitted for SDT during the previous SDT procedure. Security principle is to not repeat the same set of parameters for more than one packet. To avoid security issue, in an embodiment of the disclosure, the UE re-initializes the PDCP state variable TX_NEXT to the value at the time of entering RRC_INACTIVE or at the time of termination of previous SDT procedure in case of initiation of SDT procedure in the camped cell after the termination of a previously initiated SDT procedure, RX_NEXT and RX_DELIV are set according to first received packet during SDT. In an alternate embodiment of the disclosure, DRBs for which SDT is allowed, new DRB IDs can be indicated by gNB in RRCRelease message. These new IDs are used when DRBs are resumed for SDT.

Option 2: In the Msg3 payload, the UE sends full/short I-RNTI (resumeIdentity), ResumeMAC-I, Uplink data size included in RRC message/MAC CE to the gNB on SRB 0. ResumeMAC-I is generated as explained earlier.
Option 2-1: New RRC messages are defined: RRCResumeRequestSDT/RRCResumeRequestSDT1.
   RRCResumeRequestSDT/RRCResumeRequestSDT1 includes Resume Identity, ResumeMAC-I, Uplink data size. No resume cause.
Option 2-2: RRCResumeRequest/RRCResumeRequest1 are used with modification.
   Spare bit indicates resume is for small data transmission.
   Resume cause code points indicates Uplink data size.

Option 2-3: RRCResumeRequest/RRCResumeRequest1 includes Resume Identity, ResumeMAC-I, Resume cause.
Uplink data size is included in a new MAC CE or BSR (e.g., short BSR) is included to indicate uplink data size.

The UE resumes SRB(s) and DRB(s). Instead of resuming all DRBs and re-establishing PDCP/RLC entities for all DRBs in the above operation, the UE resumes and re-establishes only those DRBs for which small data transmission is allowed. The UE resumes SRB0 and SRB1. The UE resumes and re-establishes (PDCP entity and RLC entity) of SRB2 only if small data transmission is allowed for SRB2.

The DRBs for which small data transmission is allowed can be signaled by gNB (e.g., in RRCRelease message or any other RRC signaling message). One or more DRB identities of DRBs for which small data transmission is allowed can be included in RRCRelease message.

The UE derives new security keys using the NextHopChainingCount provided in the RRCRelease message of the previous RRC connection and re-establishes the AS security. The user data are ciphered and integrity protected (Only for DRBs configured with UP integrity protection).

In an embodiment of the disclosure, if UE's current serving cell is same as the PCell where the UE was connected to prior to suspension of the RRC connection, or if the UE's current serving cell belongs to the same gNB as the gNB of the PCell where the UE was connected to prior to suspension of the RRC connection, or if the UE's current serving cell is same as the PCell where the UE was connected to prior to suspension of the RRC connection and integrity protection is enabled for the DRB which triggered small data transmission, or if the UE's current serving cell belongs to the same gNB as the gNB of the PCell where the UE was connected to prior to suspension of the RRC connection and integrity protection is enabled for the DRB which triggered small data transmission, the UE does not derive new security keys. The UE uses the security keys in stored AS context for SRBs and DRBs.

If security key in stored AS context is used, security parameters (BEARER, DIRECTION, COUNT) will be same for packet transmitted when RRC connected and packet transmitted for SDT. Similarly, when the UE derives new security keys using the NextHopChainingCount upon initiation of SDT procedure in the camped cell after the termination of a previously initiated SDT procedure, security parameters (BEARER, DIRECTION, COUNT) and security key will be same for packet transmitted for SDT during this SDT procedure and packet transmitted for SDT during the previous SDT procedure. Security principle is to not repeat the same set of parameters for more than one packet. To avoid security issue, in an embodiment of the disclosure, the UE re-initializes the PDCP state variable TX_NEXT to the value at the time of entering RRC_INACTIVE or at the time of termination of previous SDT procedure in case of initiation of SDT procedure in the camped cell after the termination of a previously initiated SDT procedure, RX_NEXT and RX_DELIV are set according to first received packet during SDT. In an alternate embodiment of the disclosure, DRBs for which SDT is allowed, new DRB Ids can be indicated by gNB in RRCRelease message. These new IDs are used when DRBs are resumed for SDT.

Option 3: RRC-less approach wherein RRC message is not included in Msg3.

Upon receiving Msg3, gNB needs to identify the UE which has transmitted Msg3. For UE identification one of the following information can be included in Msg3.
Option 3-1-1: C-RNTI (C-RNTI used by the UE during the last RRC connection)
Option 3-1-2: Full I-RNTI
Option 3-1-3: Short I-RNTI
The UE ID to be used can be pre-defined in spec, or network can indicate which one of the above IDs are included in Msg3
The UE ID is included in MAC CE.

Upon receiving Msg3, gNB should be able to authenticate the UE which has transmitted UL data in Msg3. For authentication one of the following can be considered.
Option 3-2-1: Generate MAC-I over UL data.
   MAC CE including the UE ID+MAC SDU(s) including integrity protected UL data and MAC-I is transmitted in Msg3.
Option 3-2-2: Generate resumeMAC-I.
   MAC CE including the UE ID and resumeMAC-I+MAC SDU(s) including UL data is transmitted in Msg3
Option 3-2-3: Generate MAC-I over UL data if integrity protection is enabled for DRB whose UL data is included in Msg3. Otherwise generate resumeMAC-I.
   MAC CE will include the UE ID or UE ID+resumeMAC-I
Option 3-2-4: Authentication only if integrity protection for DRBs is enabled.
   MAC CE including the UE ID+MAC SDU(s) including UL data is transmitted in Msg3. UL data may or may not be integrity protected depending on whether IP is enabled or not for the corresponding DRB.

The UE resumes SRB(s) and DRB(s). Instead of resuming all DRBs and re-establishing PDCP/RLC entities for all DRBs in the above operation, the UE resumes and re-establishes only those DRBs for which small data transmission is allowed.

The DRBs for which small data transmission is allowed can be signaled by gNB (e.g., in RRCRelease message or any other RRC signaling message). One or more DRB identities of DRBs for which small data transmission is allowed can be included in RRCRelease message. The UE resumes SRB 0 and SRB1. The UE resumes and re-establishes (PDCP entity and RLC entity) of SRB2 only if small data transmission is allowed for SRB2.

The UE derives new security keys using the NextHopChainingCount provided in the RRCRelease message of the previous RRC connection and re-establishes the AS security. The user data are ciphered and integrity protected (Only for DRBs configured with UP integrity protection).

In an embodiment of the disclosure, if the UE's current serving cell is same as the PCell where the UE was connected to prior to suspension of the RRC connection or if the UE's current serving cell belongs to the same gNB as the gNB of the PCell where the UE was connected to prior to suspension of the RRC connection or if the UE's current serving cell is same as the PCell where the UE was connected to prior to suspension of the RRC connection and integrity protection is enabled for the DRB which triggered small data transmission or if the UE's current serving cell belongs to the same gNB as the gNB of the PCell where the UE was connected to prior to suspension of the RRC connection and integrity protection is enabled for the DRB which triggered small data transmission, the UE does not derive new security keys. The UE uses the security keys in stored AS context for SRBs and DRBs.

If security key in stored AS context is used, security parameters (BEARER, DIRECTION, COUNT) will be same for packet transmitted when RRC connected and packet transmitted for SDT. Similarly, when the UE derives new security keys using the NextHopChainingCount upon initiation of SDT procedure in the camped cell after the termination of a previously initiated SDT procedure, security parameters (BEARER, DIRECTION, COUNT) and security key will be same for packet transmitted for SDT during this SDT procedure and packet transmitted for SDT during the previous SDT procedure. Security principle is to not repeat the same set of parameters for more than one packet. To avoid security issue, in an embodiment of the disclosure, the UE re-initializes the PDCP state variable TX_NEXT to the value at the time of entering RRC_INACTIVE or at the time of termination of previous SDT procedure in case of initiation of SDT procedure in the camped cell after the termination of a previously initiated SDT procedure, RX_NEXT and RX_DELIV are set according to first received packet during SDT. In an alternate embodiment of the disclosure, DRBs for which SDT is allowed, new DRB Ids can be indicated by gNB in RRCRelease message. These new IDs are used when DRBs are resumed for SDT.

Upon transmitting Msg3, the UE monitors PDCCH addressed to TC-RNTI wherein the TC-RNTI is received in RAR. The UE monitors PDCCH addressed to TC-RNTI in search space indicated by ra-search space in operation 445. The UE assumes that the DM-RS antenna port associated with PDCCH receptions is quasi co-located with the SS/PBCH block the UE identified during the random access procedure. The gNB upon receiving Msg3, transmits Msg4.

In an embodiment wherein the RRC message was transmitted by the UE in Msg3, the Msg4 includes contention resolution identity in operation 440. The contention resolution is successful if first 48 bits of RRC message (i.e., CCCH SDU) transmitted in Msg3 matches the contention resolution identity received from gNB. In an embodiment wherein the RRC message was not transmitted by the UE in Msg3, the Msg4 includes MAC CE which contains a UE ID (e.g., C-RNTI or I-RNTI) transmitted by the UE in Msg3. The contention resolution is successful if the UE ID received matches the UE ID transmitted by the UE in Msg3. Note that this is different from current procedure wherein if C-RNTI MAC CE is transmitted in Msg3, contention resolution is successful if the UE received PDCCH addressed to C-RNTI. Note that for SDT, C-RNTI sent by the UE is the one from stored AS context and this may be allocated to other UEs while the UE is in RRC_INACTIVE.
If C-RNTI MAC CE was included in Msg3:
   If this RA procedure is initiated for SDT:
      if the UE receives PDCCH addressed to TC-RNTI and DL TB scheduled by this included MAC CE including C-RNTI transmitted by the UE in Msg3
         Contention resolution is successful. Stop contention resolution timer.
   Else:
      if the Random Access procedure was initiated for SpCell beam failure recovery and the PDCCH transmission is addressed to the C-RNTI; or
      if the Random Access procedure was initiated by a PDCCH order and the PDCCH transmission is addressed to the C-RNTI; or
      if the Random Access procedure was initiated by the MAC sublayer itself or by the RRC sublayer and the PDCCH transmission is addressed to the C-RNTI and contains a UL grant for a new transmission:
         Contention resolution is successful. Stop contention resolution timer.

Upon contention resolution TC-RNTI is promoted to C-RNTI and RA procedure is considered successfully completed in operation 450.

Upon completion of RA procedure initiated for small data transmission, the UE monitors PDCCH addressed to C-RNTI for subsequent DL/UL transmission/receptions in operations 460, 465. Note that the UE is still in RRC_INACTIVE state. The UE monitors PDCCH addressed to C-RNTI in RRC_INACTIVE until SDT is terminated, i.e., until receiving RRCRelease or MAC CE/DCI explicitly terminating SDT or expiry of timer or termination indication in Msg4 or reception of RRCResume or reception of RRCReject or reception of RRCSetup in operation 470.

The UE assumes that the DM-RS antenna port associated with the PDCCH reception is quasi co-located with the SS/PBCH block the UE identified during the above random access procedure initiated for small data transmission. The UE needs to know search space for monitoring PDCCH for subsequent DL/UL transmission/receptions. One of the following options can be used for determining search space for monitoring PDCCH for subsequent DL/UL transmission/receptions during the SDT procedure in operation 465.
Option 3-3-1: sdt-SearchSpace for subsequent DL/UL transmission/receptions is signaled by network for random access based small data transmission procedure.
   It can be signaled by network in RRCRelease message of last RRC connection.
      3-3-1-1: sdt-SearchSpace indicates one of the search space in PDCCH-ConfigCommon IE of initial DL BWP.
      3-3-1-2: sdt-SearchSpace indicates one of the search space in PDCCH-Config IE of initial DL BWP.
   sdt-SearchSpace can be signaled by network in initial DL BWP configuration (PDCCH-ConfigCommon IE or PDCCH-Config IE) or in PDCCH-ConfigCommon in SIB1.
   sdt-SearchSpace indicates the search space id of the search space configuration to be used for PDCCH monitoring.
   The UE monitors the PDCCH monitoring occasions of indicated search space using the RX beam corresponding to SSB identified during the above random access procedure.
   If sdt-SearchSpace is not signaled by gNB (i.e., if sdt- for subsequent DL/UL transmission/receptions is not signaled by network for random access based small data transmission procedure):
      The UE monitors PDCCH addressed to C-RNTI in ra-SearchSpace, for ‘subsequent UL/DL transmissions’; or
      The UE monitors PDCCH addressed to C-RNTI in search space zero, for ‘subsequent UL/DL transmissions’.
Option 3-3-2:
   The UE monitors PDCCH addressed to C-RNTI in search space zero, for ‘subsequent UL/DL transmission following UL SDT without transitioning to RRC_CONNECTED’.
Option 3-3-3:
   The UE monitors PDCCH addressed to C-RNTI in ra-SearchSpace, for ‘subsequent UL/DL transmission’.
Option 3-3-4:
   The UE monitors PDCCH addressed to C-RNTI in PDCCH-Config of PCell in the stored AS context.
   Whether the UE can use it or not can be indicated in Msg4, or
   The UE can use it only if the UE is in same serving cell as the PCell of last RRC connection. If PDCCH-Config cannot be used, one of the above options is used.
Upon completion of RA procedure initiated for SDT, the UE monitors PDCCH addressed to C-RNTI in this search space (as determined above) until SDT is completed/terminated or SDT procedure timer expires or UE enters connected.

In an embodiment of the disclosure, SDT procedure is terminated if time alignment timer expires. Alternately, the UE may initiate RA procedure upon expiry of time alignment timer while SDT procedure is ongoing. Alternately upon expiry of time alignment timer while SDT procedure is ongoing, the UE may suspend UL transmission and wait of PDCCH order to initiate RACH.

During the subsequent DL/UL transmission/reception phase of SDT procedure, gNB can send TA command MAC CE to adjust the TA of primary timing advance group (PTAG) (i.e., TAG of current camped cell, i.e., a PCell). Upon receiving such command UE applies the TA command and restart the time alignment timer.

### Embodiment 2—Handling SSB Change During Subsequent DL/UL Transmissions/Reception Phase of SDT Procedure

Upon completion of RA procedure for SDT, for subsequent UL/DL transmissions in RRC_INACTIVE state, the UE monitors PDCCH addressed to C-RNTI as explained earlier. PDCCH transmission/reception is QCLed with SSB identified during the RA procedure. Here, how to handle the case if SSB identified during RA procedure is no longer suitable will be explained. If the UE continues PDCCH monitoring using SSB which is not suitable, it will not receive PDCCH and eventually timer which the UE has started upon initiation of SDT will be stopped. This delays UL transmission and increases UE power consumption. In an embodiment the procedure to handle SSB change is as follows:

After the completion of RA procedure initiated for SDT and until the SDT procedure is completed/terminated:
The UE measures (e.g., periodically) the SS-RSRP of SSB selected during the RA procedure (or the last completed RA procedure) or the last selected SSB during the SDT procedure.
If SS-RSRP is below a threshold (or below a threshold for ‘N’ consecutive measurements or below a threshold ‘N’ times within a time interval, time interval can be configured):
   Option 4-1-1:
      The UE initiates RA procedure. During the RA procedure the UE transmits C-RNTI MAC CE in Msg3/MsgA. The C-RNTI included in MAC CE is the C-RNTI received during the last RA procedure i.e., RA procedure initiated for SDT.
   Option 4-1-2:
      The UE terminates the ongoing SDT procedure.
      The UE initiates the SDT procedure again if criteria to initiate SDT is met.

(Alternate approach) After the completion of RA procedure initiated for SDT and until the SDT procedure is completed/terminated:
The UE measures (e.g., periodically) the SS-RSRP of SSB selected during the RA procedure (or the last completed RA procedure) or the last selected SSB during the SDT procedure.
if measured SS-RSRP of SSB is below a threshold:
   start or restart the detection timer;
   increment COUNTER by 1;
   if COUNTER>=MaxCount:
      Option 4-2-1:
         The UE initiates RA procedure. During the RA procedure UE transmits C-RNTI MAC CE in Msg3/MsgA. The C-RNTI included in MAC CE is the C-RNTI received during the last RA procedure, i.e., RA procedure initiated for SDT.
      Option 4-2-2:
         The UE terminates the ongoing SDT procedure.
         The UE initiates the SDT procedure again if criteria to initiate SDT is met.
If detection timer expires, set COUNTER to 0.
detection timer value, MaxCount are configured by GNB in system information or dedicated RRC signaling message (e.g., an RRCRelease message or RRCReconfiguration message)

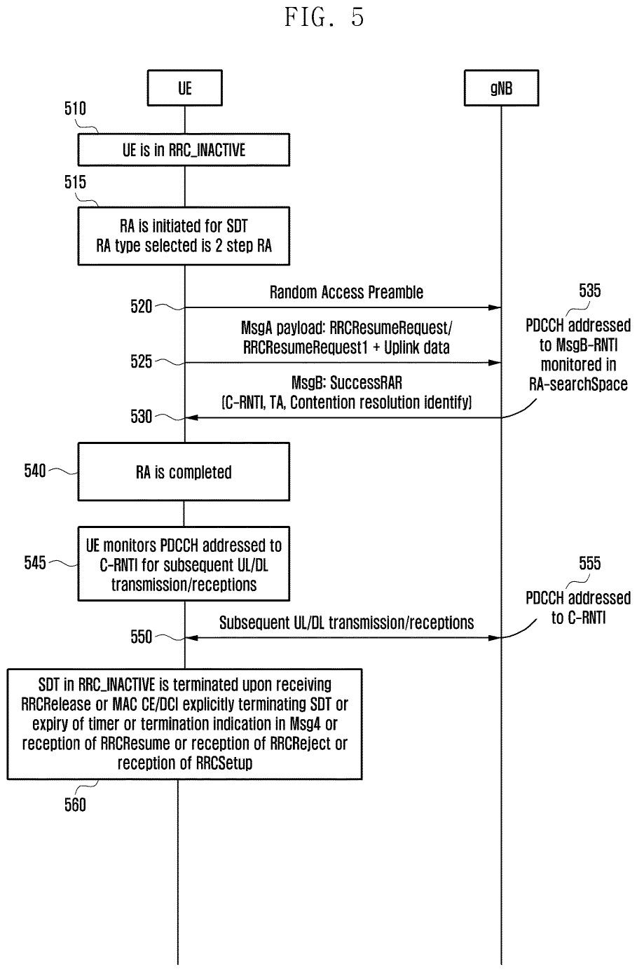

FIG. 5 illustrates a flowchart for small data transmission according an embodiment of the disclosure.

FIG. 5 is an example signaling flow between the UE and the gNB for SDT using 2 step RA.

Referring FIG. 5, the UE is in RRC_INACTIVE state in operation 510.

The UE initiate RA for SDT when the criteria to initiate SDT is met. The UE starts a timer for SDT. The value of timer is configured/signaled by gNB in system information of camped cell or in RRCRelease message or in RRCReconfiguration message. If not signaled, the UE can use default value of timer for SDT.

For RA initiated for SDT, the UE selects 2 step RA in operation 515 in this embodiment. Criteria to perform SDT and RA type selection for SDT is detailed later in the description.

The UE select an SSB. If there is at least one SSB available whose SS-RSRP is above a configured threshold (signaled by gNB in system information), the UE select SSB whose SS-RSRP is above a configured threshold. Otherwise, the UE select any SSB. The UE select preamble/RO/PUSCH occasion corresponding to selected SSB from preambles/ROs/PUSCH occasions for SDT. The UE transmits random access preamble in selected RO in operation 520.

The UE transmit MsgA payload in selected PUSCH occasion in operation 525. MsgA Payload can be generated using one of the following ways:
Option 5-1:

In the MsgA payload, the UE sends an RRCResumeRequest/RRCResumeRequest 1 to the gNB on SRB 0. It includes full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA or EIA) in the stored AS security context, which was negotiated between the UE and the last serving gNB and the K_{RRCint} from the stored AS security context with the following inputs:
KEY: it shall be set to current K_{RRCint};
BEARER: all its bits shall be set to 1.
DIRECTION: its bit shall be set to 1;
COUNT: all its bits shall be set to 1;
MESSAGE: it shall be set to VarResumeMAC-Input with following inputs:
   source PCI (set to the physical cell identity of the PCell the UE was connected to prior to suspension of the RRC connection)
   target Cell-ID (Set to the cellIdentity of the first PLMN-Identity included in the PLMN-IdentityInfoList broadcasted in SIB1 of the target cell, i.e., the cell to which the UE is sending small data)
   source C-RNTI (Set to C-RNTI that the UE had in the PCell it was connected to prior to suspension of the RRC connection).

The UE resumes SRB(s) and DRB(s). Instead of resuming all DRBs and re-establishing PDCP/RLC entities for all DRBs in the above operation, the UE resumes and re-establishes only those DRBs for which small data transmission is allowed. The UE resumes SRB 0 and SRB1. The UE resumes and re-establishes (PDCP entity and RLC entity) of SRB2 only if small data transmission is allowed for SRB2.

The DRBs for which small data transmission is allowed can be signaled by gNB (e.g., in an RRCRelease message or any other RRC signaling message). One or more DRB identities of DRBs for which small data transmission is allowed can be included in RRCRelease message.

The UE derives new security keys using the NextHopChainingCount provided in the RRCRelease message of the previous RRC connection and re-establishes the AS security. The user data are ciphered and integrity protected (Only for DRBs configured with UP integrity protection) and transmitted on DTCH multiplexed with the RRCResumeRequest/RRCResumeRequest1 message on CCCH/CCCH1. Note that depending on size of UL grant, DTCH may or may not be multiplexed with CCCH/CCCH1. Uplink data size may also be included wherein a new MAC CE or BSR MAC CE is included in MsgA.

In an embodiment of the disclosure, if the UE's current serving cell is same as the PCell where the UE was connected to prior to suspension of the RRC connection, or if the UE's current serving cell belongs to the same gNB as the gNB of the PCell where the UE was connected to prior to suspension of the RRC connection, or if the UE's current serving cell is same as the PCell where the UE was connected to prior to suspension of the RRC connection and integrity protection is enabled for the DRB which triggered small data transmission, or if the UE's current serving cell belongs to the same gNB as the gNB of the PCell where the UE was connected to prior to suspension of the RRC connection and integrity protection is enabled for the DRB which triggered small data transmission, the UE does not derive new security keys. The UE uses the security keys in stored AS context for SRBs and DRBs.

If security key in stored AS context is used, security parameters (BEARER, DIRECTION, COUNT) will be same for packet transmitted when RRC connected and packet transmitted for SDT. Similarly, when the UE derives new security keys using the NextHopChainingCount upon initiation of SDT procedure in the camped cell after the termination of a previously initiated SDT procedure, security parameters (BEARER, DIRECTION, COUNT) and security key will be same for packet transmitted for SDT during this SDT procedure and packet transmitted for SDT during the previous SDT procedure. Security principle is to not repeat the same set of parameters for more than one packet. To avoid security issue, in an embodiment of the disclosure, the UE re-initializes the PDCP state variable TX_NEXT to the value at the time of entering RRC_INACTIVE or at the time of termination of previous SDT procedure in case of initiation of SDT procedure in the camped cell after the termination of a previously initiated SDT procedure, RX_NEXT and RX_DELIV are set according to first received packet during SDT. In an alternate embodiment of the disclosure, DRBs for which SDT is allowed, new DRB Ids can be indicated by gNB in RRCRelease message. These new IDs are used when DRBs are resumed for SDT.
Option 5-2: In the MsgA payload, the UE sends full/short I-RNTI (resumeIdentity), ResumeMAC-I, Uplink data size included in RRC message/MAC CE to the gNB on SRB 0. ResumeMAC-I is generated as explained earlier.
   Option 5-2-1: New RRC messages are defined: RRCResumeRequestSDT/RRCResumeRequestSDT1.
      RRCResumeRequestSDT/RRCResumeRequestSDT1 includes Resume Identity, ResumeMAC-I, Uplink data size. No resume cause.
   Option 5-2-2: RRCResumeRequest/RRCResumeRequest1 are used with modification.
      Spare bit indicates resume is for small data transmission.
      Resume cause code points indicates Uplink data size.
   Option 5-2-3: RRCResumeRequest/RRCResumeRequest1 includes Resume Identity, ResumeMAC-I, Resume cause.
      Uplink data size is included in a new MAC CE or BSR (e.g., a short BSR) is included to indicate uplink data size.

The UE resumes SRB(s) and DRB(s). Instead of resuming all DRBs and re-establishing PDCP/RLC entities for all DRBs in the above operation, the UE resumes and re-establishes only those DRBs for which small data transmission is allowed. The UE resumes SRB0 and SRB1. The UE resumes and re-establishes (PDCP entity and RLC entity) of SRB2 only if small data transmission is allowed for SRB2.

The DRBs for which small data transmission is allowed can be signaled by gNB (e.g., in an RRCRelease message or any other RRC signaling message). One or more DRB identities of DRBs for which small data transmission is allowed can be included in RRCRelease message.

The UE derives new security keys using the NextHopChainingCount provided in the RRCRelease message of the previous RRC connection and re-establishes the AS security. The user data are ciphered and integrity protected (Only for DRBs configured with UP integrity protection).

In an embodiment of the disclosure, if the UE's current serving cell is same as the PCell where the UE was connected to prior to suspension of the RRC connection or if the UE's current serving cell belongs to the same gNB as the gNB of the PCell where the UE was connected to prior to suspension of the RRC connection or if the UE's current serving cell is same as the PCell where the UE was connected to prior to suspension of the RRC connection and integrity protection is enabled for the DRB which triggered small data transmission or if the UE's current serving cell belongs to the same gNB as the gNB of the PCell where the UE was connected to prior to suspension of the RRC connection and integrity protection is enabled for the DRB which triggered small data transmission, the UE does not derive new security keys. The UE uses the security keys in stored AS context for SRBs and DRBs.

If security key in stored AS context is used, security parameters (BEARER, DIRECTION, COUNT) will be same for packet transmitted when RRC connected and packet transmitted for SDT. Similarly, when the UE derives new security keys using the NextHopChainingCount upon initiation of SDT procedure in the camped cell after the termination of a previously initiated SDT procedure, security parameters (BEARER, DIRECTION, COUNT) and security key will be same for packet transmitted for SDT during this SDT procedure and packet transmitted for SDT during the previous SDT procedure. Security principle is to not repeat the same set of parameters for more than one packet. To avoid security issue, in an embodiment of the disclosure, the UE re-initializes the PDCP state variable TX_NEXT to the value at the time of entering RRC_INACTIVE or at the time of termination of previous SDT procedure in case of initiation of SDT procedure in the camped cell after the termination of a previously initiated SDT procedure, RX_NEXT and RX_DELIV are set according to first received packet during SDT. In an alternate embodiment of the disclosure, DRBs for which SDT is allowed, new DRB Ids can be indicated by gNB in RRCRelease message. These new IDs are used when DRBs are resumed for SDT.
Option 5-3: RRC-less approach wherein RRC message is not included in MsgA payload.
   Upon receiving MsgA payload, gNB needs to identify the UE which has transmitted Msg3. For the UE identification one of the following information can be included in MsgA payload.
      Option 5-3-1: C-RNTI (C-RNTI used by the UE during the last RRC connection).
      Option 5-3-2: Full I-RNTI.
      Option 5-3-3: Short I-RNTI.
      The UE ID to be used can be pre-defined in spec, or network can indicate which one of the above IDs are included in MsgA
      The UE ID is included in MAC CE.

Upon receiving MsgA payload, gNB should be able to authenticate the UE which has transmitted UL data in MsgA payload. For authentication one of the following can be considered
Option 5-4-1: Generate MAC-I over UL data.
   MAC CE including UE ID+MAC SDU(s) including integrity protected UL data and MAC-I is transmitted in MsgA payload.
Option 5-4-2: Generate resumeMAC-I.
   MAC CE including UE ID and resumeMAC-I+MAC SDU(s) including UL data is transmitted in MsgA payload.
Option 5-4-3: Generate MAC-I over UL data if integrity protection is enabled for DRB whose UL data is included in MsgA payload. Otherwise generate resumeMAC-I.
   MAC CE will include UE ID or UE ID+resumeMAC-I.
Option 5-4-4: Authentication only if integrity protection for DRBs is enabled.
   MAC CE including UE ID+MAC SDU(s) including UL data is transmitted in MsgA payload. UL data may or may not be integrity protected depending on whether IP is enabled or not for the corresponding DRB.

The UE resumes SRB(s) and DRB(s). Instead of resuming all DRBs and re-establishing PDCP/RLC entities for all DRBs in the above operation, the UE resumes and re-establishes only those DRBs for which small data transmission is allowed. The UE resumes SRB 0 and SRB1. The UE resumes and re-establishes (PDCP entity and RLC entity) of SRB2 only if small data transmission is allowed for SRB2.

The DRBs for which small data transmission is allowed can be signaled by the gNB (e.g., in RRCRelease message or any other RRC signaling message). One or more DRB identities of DRBs for which small data transmission is allowed can be included in RRCRelease message.

The UE derives new security keys using the NextHopChainingCount provided in the RRCRelease message of the previous RRC connection and re-establishes the AS security. The user data are ciphered and integrity protected (Only for DRBs configured with UP integrity protection).

In an embodiment of the disclosure, if the UE's current serving cell is same as the PCell where the UE was connected to prior to suspension of the RRC connection or if the UE's current serving cell belongs to the same gNB as the gNB of the PCell where the UE was connected to prior to suspension of the RRC connection or if the UE's current serving cell is same as the PCell where the UE was connected to prior to suspension of the RRC connection and integrity protection is enabled for the DRB which triggered small data transmission or if the UE's current serving cell belongs to the same gNB as the gNB of the PCell where the UE was connected to prior to suspension of the RRC connection and integrity protection is enabled for the DRB which triggered small data transmission, the UE does not derive new security keys. The UE uses the security keys in stored AS context for SRBs and DRBs.

If security key in stored AS context is used, security parameters (BEARER, DIRECTION, COUNT) will be same for packet transmitted when RRC connected and packet transmitted for SDT. Similarly, when the UE derives new security keys using the NextHopChainingCount upon initiation of SDT procedure in the camped cell after the termination of a previously initiated SDT procedure, security parameters (BEARER, DIRECTION, COUNT) and security key will be same for packet transmitted for SDT during this SDT procedure and packet transmitted for SDT during the previous SDT procedure. Security principle is to not repeat the same set of parameters for more than one packet. To avoid security issue, in an embodiment of the disclosure, the UE re-initializes the PDCP state variable TX_NEXT to the value at the time of entering RRC_INACTIVE or at the time of termination of previous SDT procedure in case of initiation of SDT procedure in the camped cell after the termination of a previously initiated SDT procedure, RX_NEXT and RX_DELIV are set according to first received packet during SDT. In an alternate embodiment of the disclosure, DRBs for which SDT is allowed, new DRB Ids can be indicated by gNB in RRCRelease message. These new IDs are used when DRBs are resumed for SDT.

Upon transmitting preamble and MsgA payload, the UE monitors PDCCH addressed to MsgB-RNTI in MsgB response window. The PDCCH monitoring occasions monitored by the UE within the MsgB response window are indicated by search space parameters identified by ra-search space in operation 535. Multiple sets of search space parameters are signaled by camped cell in system information. Each set is identified by search space ID. The parameter ra-search space indicates the search space ID. The MsgB-RNTI is calculated as follows: RA-RNTI=1+s_id+14*t_id+14*80*f_id+14*80*8*ul_carrier_id+14*80*8*2, where s_id is the index of the first orthogonal frequency division multiplexing (OFDM) symbol of the PRACH occasion where the UE has transmitted RA preamble, 0≤s_id<14, t_id is the index of the first slot of the PRACH occasion (0≤t_id<80), f_id is the index of the PRACH occasion within the slot in the frequency domain (0≤f_id<8), and ul_carrier_id is the UL carrier used for MsgA transmission (0 for NUL carrier and 1 for SUL carrier.

The UE receives MsgB in operation 530. MsgB includes successRAR wherein the successRAR includes TA, C-RNTI. In an embodiment wherein the RRC message was transmitted by the UE in MsgA payload, the MsgB also includes contention resolution identity. The contention resolution is successful if first 48 bits of RRC message (i.e., CCCH SDU) transmitted in MsgA payload matches the contention resolution identity received from gNB. In an embodiment wherein the RRC message was not transmitted by the UE in MsgA payload, the MsgB includes the UE ID (e.g., C-RNTI or I-RNTI) transmitted by the UE in MsgA payload. The contention resolution is successful if the UE ID received matches the UE ID transmitted by the UE in MsgA payload. Upon contention resolution RA procedure is considered successfully completed. The UE applies the TA and start time alignment timer.

Upon completion of 2 step RA procedure in operation 540 initiated for SDT, the UE monitors PDCCH addressed to C-RNTI (i.e., C-RNTI received in successRAR) for subsequent DL/UL transmission/receptions in operations 545, 550, 555. Note that the UE is still in RRC_INACTIVE state. The UE monitors PDCCH addressed to C-RNTI in RRC_INACTIVE until SDT is terminated, i.e., until receiving RRCRelease or MAC CE/DCI explicitly terminating SDT or expiry of timer or termination indication in MsgB or reception of RRCResume or reception of RRCReject or reception of RRCSetup in operation 560.

The UE assumes that the DM-RS antenna port associated with the PDCCH reception is quasi co-located with the SS/PBCH block the UE identified during the above random access procedure initiated for SDT. The UE needs to know search space for monitoring PDCCH for subsequent DL/UL transmission/receptions during the SDT procedure. One of the following options can be used for determining search space for monitoring PDCCH subsequent DL/UL transmission/receptions during the SDT procedure.
Option 6-1: sdt-SearchSpace for subsequent DL/UL transmission/receptions is signaled by network for random access based SDT procedure.
   It can be signaled by network in RRCRelease message of last RRC connection.
      6-1-1: sdt-SearchSpace indicates one of the search space in PDCCH-ConfigCommon IE of initial DL BWP.
      6-1-2: sdt-SearchSpace indicates one of the search space in PDCCH-Config IE of initial DL BWP.
   sdt-SearchSpace can be signaled by network in initial DL BWP configuration (PDCCH-ConfigCommon IE or PDCCH-Config IE) or in PDCCH-ConfigCommon in SIB1.
   sdt-SearchSpace indicates the search space id of the search space configuration to be used for PDCCH monitoring for subsequent DL/UL transmission/receptions.
   The UE monitors the PDCCH monitoring occasions of indicated search space using the RX beam corresponding to SSB identified during the above random access procedure.
   If sdt-SearchSpace is not signaled by gNB for random access based SDT procedure:
      The UE monitors PDCCH addressed to C-RNTI in ra-SearchSpace, for ‘subsequent UL/DL transmissions’; or
      The UE monitors PDCCH addressed to C-RNTI in search space zero, for ‘subsequent UL/DL transmissions’.
Option 6-2:
   The UE monitors PDCCH addressed to C-RNTI in search space zero, for ‘subsequent UL/DL transmission following UL SDT without transitioning to RRC_CONNECTED’.
Option 6-3:
   The UE monitors PDCCH addressed to C-RNTI in ra-SearchSpace, for ‘subsequent UL/DL transmission’.
Option 6-4:
   The UE monitors PDCCH addressed to C-RNTI in PDCCH-Config of PCell in the stored AS context.
   Whether the UE can use it or not can be indicated in Msg4, or
   The UE can use it only if the UE is in same serving cell as the PCell of last RRC connection. If PDCCH-Config cannot be used, one of the above options is used.
Upon completion of RA procedure for SDT, the UE monitors PDCCH addressed to C-RNTI in this search space (as determined above) until SDT is completed/terminated or SDT procedure timer expires or the UE enters connected.

In an embodiment of the disclosure, SDT procedure is terminated if time alignment timer expires. Alternately, the UE may initiate RA procedure upon expiry of time alignment timer while SDT procedure is ongoing. Alternately, the UE may suspend UL transmission and wait of PDCCH order to initiate RACH.

During the subsequent DL/UL transmission/reception phase of SDT procedure, gNB can send TA command MAC CE to adjust the TA of PTAG (i.e., TAG of current camped cell, i.e., a PCell). Upon receiving such command UE applies the TA command and restart the time alignment timer.

### Embodiment 3-1—Criteria to Perform SDT or Not

If pre-configured UL resources are configured for small data transmission and criteria to perform SDT using pre-configured UL resources is met:
   The UE performs SDT using pre-configured UL resources.
else:
   The UE selects the UL carrier (NUL or SUL).
   The UE selects the BWP (i.e., initial UL BWP/initial DL BWP) for random access procedure.
   If only 4 step RA configuration is signaled by gNB for BWP selected for random access procedure:
      Check whether criteria to perform SDT using 4 step RA is met or not. If met, perform SDT using 4 step RA. Otherwise perform normal connection resume.
   If both 2 step RA configuration and 4 step RA configuration is signaled by gNB for BWP selected for random access procedure:
      if RSRP of pathloss reference is <=threshold:
         Check whether criteria to perform SDT using 4 step RA is met or not. If met, perform SDT using 4 step RA. Otherwise perform normal connection resume.
      Else:
         Check whether criteria to perform SDT using 2 step RA is met or not. If met, perform SDT using 2 step RA. Otherwise perform normal connection resume.
   If only 2 step RA configuration is signaled by gNB for BWP selected for random access procedure:
      Check whether criteria to perform SDT using 2 step RA is met or not. If met, perform SDT using 2 step RA. Otherwise perform normal connection resume.

### Embodiment 3-2—Criteria to Determine Whether to Use 4 Step RA for SDT or Not

The UE can performs SDT using 4 step RA if the following conditions are met. Otherwise, the UE perform connection resume procedure without SDT. In an embodiment of the disclosure, a subset of the below conditions can be used.
Condition 1: the upper layer's request resumption of an RRC connection and the resumption request is for mobile originating calls and the establishment cause is mo-Data;
Condition 2: the UE supports SDT;
Condition 3: system information includes SDT configuration for 4 step RA;
Condition 4: UE has a stored value of the nextHopChainingCount provided in the RRCRelease message with suspend indication during the preceding suspend procedure. In an embodiment of the disclosure, this condition may not be used if UE's current serving cell/gNB is same as the serving cell (SpCell)/gNB at the time of last connection release.
Condition 5: RRCRelease message with suspend indication during the preceding suspend procedure indicates that the UE is allowed to perform SDT using 4 step RA.

NOTE: In order to control the UEs which can perform SDT, network can indicate whether the UE is allowed to perform SDT or not in RRCRelease. If not allowed, the UE will perform connection resume. Indication can be common for all methods of SDT. Indication can be separate for 4 step RA, 2 step RA. In one embodiment condition 5 is not used to determine SDT or not.
Condition 6: If the logical channel (LCH) restrictions for logical channel prioritization (LCP) are applied for SDT and all LCHs for which data is available for transmission is allowed to be multiplexed in Msg3/UL grant according to LCH restrictions.

Network can also indicate the DRBs for which SDT is allowed. In this case, LCHs corresponding to the DRBs for which SDT is allowed is considered. If data is available for transmission for DRBs other than DRBs for which SDT is allowed, the UE shall initiate connection resume without SDT.

In one embodiment condition 6 is not used to determine SDT or not.
Condition 7: SDT data threshold is configured and total amount of data available for SDT is <=to this threshold. Alternately, total amount of data available for SDT is <=SDT data threshold and RSRP of path loss reference is > or >=configured RSRP threshold
Condition 7': Msg3 TBS and signal quality threshold criteria as explained below is met. One of the following options can be used to configure Msg3 TBS for SDT and to determine whether to use 4 step RA for small data transmission or normal connection resume.

In an embodiment of the disclosure, one of condition 7 and condition 7′ may be used according to following option(s).
Option 7-1: Single TBS, No signal quality based threshold

The gNB configures the parameter sdt-TBS which indicates the maximum allowed transport block size for small data transmission using 4 step RA. The gNB selects a value for sdt-TBS from a set of configurable values. The parameter is separately configured for SUL and NUL as UL coverage is different for SUL and NUL.
If the message size (UL data available for transmission plus MAC header and, where required, MAC control elements) is less than equal to the TB size signaled in sdt-TBS for the UL carrier selected for the random access procedure:
   The UE initiates 4 step RA for small data transmission. Preamble group selection is not performed during this random access procedure.
Else
   The UE initiates 4 step RA for resuming connection (small data is not included).
Option 7-2: Single TBS, single RSRP Threshold

The gNB configures the parameter sdt-TBS which indicates the maximum allowed transport block size for small data transmission using 4 step RA. gNB also configures the parameter sdt-Threshold. These parameters are separately configured for SUL and NUL as UL coverage is different for SUL and NUL.
If the message size (UL data available for transmission plus MAC header and, where required, MAC control elements) is less than equal to the TB size signaled in sdt-TBS for the UL carrier selected for random access procedure and RSRP of the downlink pathloss reference is greater than or equal to sdt-Threshold:
   The UE initiates 4 step RA for small data transmission. Preamble group selection is not performed during this random access procedure.
Else:
   The UE initiates 4 step RA for resuming connection (small data is not included).
Option 7-3: Multiple [TBS size, threshold, preamble group]

The gNB configures the parameter sdt-TBS-groupA and sdt-TBS-groupB which indicates the maximum allowed transport block sizes for small data transmission using 4 step RA for preamble group A and preamble group B respectively. sdt-Threshold-groupB is also configure. These parameters are separately configured for SUL and NUL as UL coverage is different for SUL and NUL.
If the message size (UL data available for transmission plus MAC header and, where required, MAC control elements) is less than equal to the TB size signaled in sdt-TBS-groupA:
The UE performs small data transmission using 4 step RA. Group A is selected.
Else If the message size (UL data available for transmission plus MAC header and, where required, MAC control elements) is greater than TB size signaled in sdt-TBS-groupA and is less than equal to the TB size signaled in sdt-TBS-groupB for the selected UL carrier and RSRP of the downlink pathloss reference is greater than or equal to sdt-Threshold-groupB:
   The UE performs small data transmission using 4 step RA. Group B is selected.
Else:
   The UE initiates 4 step RA for resuming connection (small data is not included).

This option can be generalized wherein gNB configures the parameters sdt-TBS-group1 and sdt-TBS-groupN, sdt-Threshold-group2 to sdt-Threshold-groupN, preambles for group 1 to N.
If the message size (UL data available for transmission plus MAC header and, where required, MAC control elements) is less than equal to the TB size signaled in sdt-TBS-group1:
   The UE performs small data transmission using 4 step RA. Group 1 is selected.
Else If the message size (UL data available for transmission plus MAC header and, where required, MAC control elements) is greater than TB size signaled in sdt-TBS-group1 and is less than equal to the TB size signaled in sdt-TBS-group2 for the selected UL carrier and RSRP of the downlink pathloss reference is greater than or equal to sdt-Threshold-group2
   The UE performs small data transmission using 4 step RA. Group 2 is selected.
Else If the message size (UL data available for transmission plus MAC header and, where required, MAC control elements) is greater than TB size signaled in sdt-TBS-group2 and is less than equal to the TB size signaled in sdt-TBS-group3 for the selected UL carrier and RSRP of the downlink pathloss reference is greater than or equal to sdt-Threshold-group3
   The UE performs small data transmission using 4 step RA. Group 3 is selected.
Else If the message size (UL data available for transmission plus MAC header and, where required, MAC control elements) is greater than TB size signaled in sdt-TBS-groupN-1 and is less than equal to the TB size signaled in sdt-TBS-groupN for the selected UL carrier and RSRP of the downlink pathloss reference is greater than or equal to sdt-Threshold-groupN:
   The UE performs small data transmission using 4 step RA. Group N is selected.
Else:
   The UE initiates 4 step RA for resuming connection (small data is not included)
Option 7-3A:

The gNB configures the parameter sdt-TBS-groupA and sdt-TBS-groupB which indicates the maximum allowed transport block sizes for small data transmission using 4 step RA for preamble group A and preamble group B respectively. sdt-Threshold-groupA and sdt-Threshold-groupB is also configured. These parameters are separately configured for SUL and NUL as UL coverage is different for SUL and NUL.
If the message size (UL data available for transmission plus MAC header and, where required, MAC control elements) is less than equal to the TB size signaled in sdt-TBS-groupA and RSRP of the downlink pathloss reference is greater than or equal to sdt-Threshold-groupA:
   The UE performs small data transmission using 4 step RA. Group A is selected.
Else If the message size (UL data available for transmission plus MAC header and, where required, MAC control elements) is greater than TB size signaled in sdt-TBS-groupA and is less than equal to the TB size signaled in sdt-TBS-groupB for the selected UL carrier and RSRP of the downlink pathloss reference is greater than or equal to sdt-Threshold-groupB:
   The UE performs small data transmission using 4 step RA. Group B is selected.
Else:
   The UE initiates 4 step RA for resuming connection (small data is not included).

This option can be generalized wherein gNB configures the parameters sdt-TBS-group1 and sdt-TBS-groupN, sdt-Threshold-group1 to sdt-Threshold-groupN, preambles for group 1 to N.
If the message size (UL data available for transmission plus MAC header and, where required, MAC control elements) is less than equal to the TB size signaled in sdt-TBS-group1 and RSRP of the downlink pathloss reference is greater than or equal to sdt-Threshold-group1:
   The UE performs small data transmission using 4 step RA. Group 1 is selected.
Else If the message size (UL data available for transmission plus MAC header and, where required, MAC control elements) is greater than TB size signaled in sdt-TBS-group1 and is less than equal to the TB size signaled in sdt-TBS-group2 for the selected UL carrier and RSRP of the downlink pathloss reference is greater than or equal to sdt-Threshold-group2:
   The UE performs small data transmission using 4 step RA. Group 2 is selected.
Else If the message size (UL data available for transmission plus MAC header and, where required, MAC control elements) is greater than TB size signaled in sdt-TBS-group2 and is less than equal to the TB size signaled in sdt-TBS-group3 for the selected UL carrier and RSRP of the downlink pathloss reference is greater than or equal to sdt-Threshold-group3:
   The UE performs small data transmission using 4 step RA. Group 3 is selected.
Else If the message size (UL data available for transmission plus MAC header and, where required, MAC control elements) is greater than TB size signaled in sdt-TBS-groupN-1 and is less than equal to the TB size signaled in sdt-TBS-groupN for the selected UL carrier and RSRP of the downlink pathloss reference is greater than or equal to sdt-Threshold-groupN:
   The UE performs small data transmission using 4 step RA. Group N is selected.
Else:
   The UE initiates 4 step RA for resuming connection (small data is not included).
Option 7-4: Single TBS, single messagePowerOffsetSDT for pathloss threshold.

The gNB configures the parameter sdt-TBS which indicates the maximum allowed transport block size for small data transmission using 4 step RA. gNB also configures the parameter messagePowerOffsetSDT. These parameters are separately configured for SUL and NUL as UL coverage is different for SUL and NUL.
If the message size (UL data available for transmission plus MAC header and, where required, MAC control elements) is less than equal to the TB size signaled in sdt-TBS for the UL carrier selected for random access procedure and the pathloss is less than PCMAX (of the Serving Cell performing the Random Access Procedure)−preambleReceivedTargetPower−msg3-DeltaPreamble−messagePowerOffsetSDT:
   The UE initiates 4 step RA for small data transmission.
Else:
   The UE initiates 4 step RA for resuming connection (small data is not included).
Option 7-5: Multiple [TBS size, messagePowerOffsetSDT, preamble group]

The gNB configures the parameter sdt-TBS-groupA and sdt-TBS-groupB which indicates the maximum allowed transport block sizes for small data transmission using 4 step RA for preamble group A and preamble group B respectively. These parameters are separately configured for SUL and NUL as UL coverage is different for SUL and NUL.
If the message size (UL data available for transmission plus MAC header and, where required, MAC control elements) is less than equal to the TB size signaled in sdt-TBS-groupA:
   The UE performs small data transmission using 4 step RA. Group A is selected.
Else If the message size (UL data available for transmission plus MAC header and, where required, MAC control elements) is greater than TB size signaled in sdt-TBS-groupA and is less than equal to the TB size signaled in sdt-TBS-groupB for the selected UL carrier and the pathloss is less than PCMAX (of the Serving Cell performing the Random Access Procedure)−preambleReceivedTargetPower−msg3-DeltaPreamble−messagePowerOffsetGroupB
   The UE performs small data transmission using 4 step RA. Group B is selected.
Else:
   The UE initiates 4 step RA for resuming connection (small data is not included).

This option can be generalized wherein gNB configures the parameters sdt-TBS-group1 and sdt-TBS-groupN, messagePowerOffsetGroup2 to messagePowerOffsetGroupN, preambles for group 1 to N.
If the message size (UL data available for transmission plus MAC header and, where required, MAC control elements) is less than equal to the TB size signaled in sdt-TBS-group1:
   The UE performs small data transmission using 4 step RA. Group 1 is selected.
Else If the message size (UL data available for transmission plus MAC header and, where required, MAC control elements) is greater than TB size signaled in sdt-TBS-group1 and is less than equal to the TB size signaled in sdt-TBS-group2 for the selected UL carrier and the pathloss is less than PCMAX (of the Serving Cell performing the Random Access Procedure)−preambleReceivedTargetPower−msg3-DeltaPreamble−messagePowerOffsetGroup2
   The UE performs small data transmission using 4 step RA. Group 2 is selected.
Else If the message size (UL data available for transmission plus MAC header and, where required, MAC control elements) is greater than TB size signaled in sdt-TBS-group2 and is less than equal to the TB size signaled in sdt-TBS-group3 for the selected UL carrier and the pathloss is less than PCMAX (of the Serving Cell performing the Random Access Procedure)−preambleReceivedTargetPower−msg3-DeltaPreamble−messagePowerOffsetGroup3
   The UE performs small data transmission using 4 step RA. Group 3 is selected.
Else If the message size (UL data available for transmission plus MAC header and, where required, MAC control elements) is greater than TB size signaled in sdt-TBS-groupN-1 and is less than equal to the TB size signaled in sdt-TBS-groupN for the selected UL carrier and the pathloss is less than PCMAX (of the Serving Cell performing the Random Access Procedure)−preambleReceivedTargetPower−msg3-DeltaPreamble−messagePowerOffsetGroupN:
   The UE performs small data transmission using 4 step RA. Group N is selected.
Else:
   The UE initiates 4 step RA for resuming connection (small data is not included).
Option 7-5A:

The gNB configures the parameter sdt-TBS-groupA and sdt-TBS-groupB which indicates the maximum allowed transport block sizes for small data transmission using 4 step RA for preamble group A and preamble group B respectively. These parameters are separately configured for SUL and NUL as UL coverage is different for SUL and NUL.
If the message size (UL data available for transmission plus MAC header and, where required, MAC control elements) is less than equal to the TB size signaled in sdt-TBS-groupA and the pathloss is less than PCMAX (of the Serving Cell performing the Random Access Procedure)−preambleReceivedTargetPower−msg3-DeltaPreamble−messagePowerOffsetGroupA:
   The UE performs small data transmission using 4 step RA. Group A is selected.
Else If the message size (UL data available for transmission plus MAC header and, where required, MAC control elements) is greater than TB size signaled in sdt-TBS-groupA and is less than equal to the TB size signaled in sdt-TBS-groupB for the selected UL carrier and the pathloss is less than PCMAX (of the Serving Cell performing the Random Access Procedure)−preambleReceivedTargetPower−msg3-DeltaPreamble−messagePowerOffsetGroupB:
   The UE performs small data transmission using 4 step RA. Group B is selected.
Else:
   The UE initiates 4 step RA for resuming connection (small data is not included).

This option can be generalized wherein gNB configures the parameters sdt-TBS-group1 and sdt-TBS-groupN, messagePowerOffsetGroup1 to messagePowerOffsetGroupN, preambles for group 1 to N.
If the message size (UL data available for transmission plus MAC header and, where required, MAC control elements) is less than equal to the TB size signaled in sdt-TBS-group1 and the pathloss is less than PCMAX (of the Serving Cell performing the Random Access Procedure)−preambleReceivedTargetPower−msg3-DeltaPreamble−messagePowerOffsetGroup1:
   The UE performs small data transmission using 4 step RA. Group 1 is selected.
Else If the message size (UL data available for transmission plus MAC header and, where required, MAC control elements) is greater than TB size signaled in sdt-TBS-group1 and is less than equal to the TB size signaled in sdt-TBS-group2 for the selected UL carrier and the pathloss is less than PCMAX (of the Serving Cell performing the Random Access Procedure)−preambleReceivedTargetPower−msg3-DeltaPreamble−messagePowerOffsetGroup2:
   The UE performs small data transmission using 4 step RA. Group 2 is selected.
Else If the message size (UL data available for transmission plus MAC header and, where required, MAC control elements) is greater than TB size signaled in sdt-TBS-group2 and is less than equal to the TB size signaled in sdt-TBS-group3 for the selected UL carrier and the pathloss is less than PCMAX (of the Serving Cell performing the Random Access Procedure)−preambleReceivedTargetPower−msg3-DeltaPreamble−messagePowerOffsetGroup3:
   The UE performs small data transmission using 4 step RA. Group 3 is selected.
Else If the message size (UL data available for transmission plus MAC header and, where required, MAC control elements) is greater than TB size signaled in sdt-TBS-groupN-1 and is less than equal to the TB size signaled in sdt-TBS-groupN for the selected UL carrier and the pathloss is less than PCMAX (of the Serving Cell performing the Random Access Procedure)−preambleReceivedTargetPower−msg3-DeltaPreamble−messagePowerOffsetGroupN:
   The UE performs small data transmission using 4 step RA. Group N is selected.
Else:
   The UE initiates 4 step RA for resuming connection (small data is not included).
Option 7-6: Multiple [TBS, preamble group]

The gNB configures the parameter sdt-TBS-groupA and sdt-TBS-groupB which indicates the maximum allowed transport block sizes for small data transmission using 4 step RA for preamble group A and preamble group B respectively. These parameters are separately configured for SUL and NUL as UL coverage is different for SUL and NUL.
If the message size (UL data available for transmission plus MAC header and, where required, MAC control elements) is less than equal to the TB size signaled in sdt-TBS-groupA:
   The UE performs small data transmission using 4 step RA. Group A is selected.
Else If the message size (UL data available for transmission plus MAC header and, where required, MAC control elements) is greater than TB size signaled in sdt-TBS-groupA and is less than equal to the TB size signaled in sdt-TBS-groupB for the selected UL carrier:
   The UE performs small data transmission using 4 step RA. Group B is selected.
Else:
   The UE initiates 4 step RA for resuming connection (small data is not included).

This option can be generalized wherein gNB configures the parameters sdt-TBS-group1 and sdt-TBS-groupN, preambles for group 1 to N.
If the message size (UL data available for transmission plus MAC header and, where required, MAC control elements) is less than equal to the TB size signaled in sdt-TBS-group1:
   The UE performs small data transmission using 4 step RA. Group 1 is selected.
Else If the message size (UL data available for transmission plus MAC header and, where required, MAC control elements) is greater than TB size signaled in sdt-TBS-group1 and is less than equal to the TB size signaled in sdt-TBS-group2 for the selected UL carrier:
   The UE performs small data transmission using 4 step RA. Group 2 is selected.
Else If the message size (UL data available for transmission plus MAC header and, where required, MAC control elements) is greater than TB size signaled in sdt-TBS-group2 and is less than equal to the TB size signaled in sdt-TBS-group3 for the selected UL carrier:
   The UE performs small data transmission using 4 step RA. Group 3 is selected.
Else If the message size (UL data available for transmission plus MAC header and, where required, MAC control elements) is greater than TB size signaled in sdt-TBS-groupN-1 and is less than equal to the TB size signaled in sdt-TBS-groupN for the selected UL:
   The UE performs small data transmission using 4 step RA. Group N is selected.
Else:
   The UE initiates 4 step RA for resuming connection (small data is not included).

### Embodiment 3-3—Criteria to Determine Whether to Use 2 Step RA for SDT or Not

The UE performs SDT using 2 step RA if the following conditions are met. Otherwise, the UE perform connection resume procedure without SDT. In an embodiment of the disclosure, a subset of the below conditions can be used.
Condition 1: the upper layers request resumption of an RRC connection and the resumption request is for mobile originating calls and the establishment cause is mo-Data;
Condition 2: the UE supports SDT;
Condition 3: system information includes SDT configuration for 2 step RA;
Condition 4: the UE has a stored value of the nextHopChainingCount provided in the RRCRelease message with suspend indication during the preceding suspend procedure. In an embodiment of the disclosure, this condition may not be used if UE's current serving cell/gNB is same as the serving cell (SpCell)/gNB at the time of last connection release.
Condition 5: RRCRelease message with suspend indication during the preceding suspend procedure indicates that the UE is allowed to perform SDT using 2 step RA.

In order to control the UEs which can perform SDT, network can indicate whether the UE is allowed to perform SDT or not in RRCRelease. If not allowed, the UE will perform connection resume. Indication can be common for all methods of SDT. Indication can be separate for 4 step RA, 2 step RA. In one embodiment condition 5 is not used to determine SDT or not.
Condition 6: If the LCH restrictions for LCP are applied for SDT and all LCHs for which data is available for transmission is allowed to be multiplexed in MsgA according to LCH restrictions.

Network can also indicate the DRBs for which SDT is allowed. In this case, LCHs corresponding to the DRBs for which SDT is allowed is considered. If data is available for transmission for DRBs other than DRBs for which SDT is allowed, the UE shall initiate connection resume without SDT, i.e., the UE does not perform SDT.

In one embodiment condition 6 is not used to determine SDT or not.
Condition 7: SDT data threshold is configured and total amount of data available for SDT is <=to this threshold. Alternately, total amount of data available for SDT is <=SDT data threshold and RSRP of path loss reference is > or >=configured RSRP threshold.
Condition 7′: MsgA TBS and signal quality threshold criteria as explained below is met. One of the following options can be used to configure MsgA TBS for SDT and to determine whether to use 2 step RA for small data transmission or normal connection resume.

In an embodiment of the disclosure, one of condition 7 and condition 7′ may be used according to following option(s).
Option 8-1: Single MsgA PUSCH configuration, No signal quality based threshold

The gNB configures a single MsgA-PUSCH-Config-SDT (i.e., a PUSCH resource pool) in 2 step RA configuration for SDT. The TBS is not explicitly signaled but determined based on SCS, number of PRBs and number of OFDM symbols of PO.
If the message size (UL data available for transmission plus MAC header and, where required, MAC control elements) is less than equal to the TB size of MsgA payload according to MsgA-PUSCH-Config-SDT on UL carrier selected for random access procedure:
   The UE initiates 2 step RA for small data transmission. Preamble group selection is not performed during this random access procedure.
Else:
   The UE initiates 2 step RA for resuming connection (small data is not included).
Option 8-2: Single MsgA PUSCH configuration, single RSRP Threshold

The gNB configures a single MsgA-PUSCH-Config-SDT (i.e., a PUSCH resource pool) in 2 step RA configuration for SDT. The TBS is not explicitly signaled but determined based on SCS, number of PRBs and number of OFDM symbols of PO. gNB also configures the parameter sdt-Threshold-MsgA. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT on UL carrier selected for random access procedure and RSRP of the downlink pathloss reference is greater than or equal to sdt-Threshold-MsgA:
   The UE initiates 2 step RA for small data transmission. Preamble group selection is not performed during this random access procedure.
Else:
   The UE initiates 4 step RA for resuming connection (small data is not included).
Option 8-3: Multiple [MsgA PUSCH configuration, threshold, preamble group]

The gNB configures the parameter MsgA-PUSCH-Config-SDT-groupA and MsgA-PUSCH-Config-SDT-group B in 2 step RA configuration for SDT. The TBS is not explicitly signaled but determined based on SCS, number of PRBs and number of OFDM symbols of PO. sdt-Threshold-MsgA-groupB is also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for random access procedure:
   The UE performs small data transmission using 2 step RA. Group A is selected.
Else If the message size (UL data available for transmission plus MAC header and, where required, MAC control elements) is less than equal to the TB size of MsgA payload according to MsgA-PUSCH-Config-SDT-groupB for the selected UL carrier and RSRP of the downlink pathloss reference is greater than or equal to sdt-Threshold-MsgA-groupB:
   The UE performs small data transmission using 2 step RA. Group B is selected.
Else:
   The UE initiates 2 step RA for resuming connection (small data is not included).

This option can be generalized wherein gNB configures the parameters MsgA-PUSCH-Config-SDT-group1 to MsgA-PUSCH-Config-SDT-groupN, sdt-Threshold-MsgA-group2 to sdt-Threshold-MsgA-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for random access procedure:
   The UE performs small data transmission using 2 step RA. Group 1 is selected.
Else If the message size (UL data available for transmission plus MAC header and, where required, MAC control elements) is less than equal to the TB size of MsgA payload according to MsgA-PUSCH-Config-SDT-group2 for SDT on UL carrier selected for random access procedure and RSRP of the downlink pathloss reference is greater than or equal to sdt-Threshold-MsgA-group2:
   The UE performs small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (‘is greater than TB size of MsgA payload according to MsgA-PUSCH-Config-SDT-group2 and’ can be removed in one embodiment) is less than equal to the TB size of MsgA payload according to MsgA-PUSCH-Config-SDT-group3 for SDT on UL carrier selected for random access procedure and RSRP of the downlink pathloss reference is greater than or equal to sdt-Threshold-MsgA-group3:
   The UE performs small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN-1 and (‘is greater than TB size of MsgA payload according to MsgA-PUSCH-Config-SDT-groupN-1 and’ can be removed in one embodiment) is less than equal to the TB size of MsgA payload according to MsgA-PUSCH-Config-SDT-groupN for SDT on UL carrier selected for random access procedure and RSRP of the downlink pathloss reference is greater than or equal to sdt-Threshold-MsgA-groupN:
   The UE performs small data transmission using 2 step RA. Group N is selected.
Else:
   The UE initiates 2 step RA for resuming connection (small data is not included).
Option 8-3A:

The gNB configures the parameter MsgA-PUSCH-Config-SDT-groupA and MsgA-PUSCH-Config-SDT- in 2 step RA configuration for SDT. The TBS is not explicitly signaled but determined based on SCS, number of PRBs and number of OFDM symbols of PO. sdt-Threshold-MsgA-groupA and sdt-Threshold-MsgA-groupB are also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for random access procedure and RSRP of the downlink pathloss reference is greater than or equal to sdt-Threshold-MsgA-groupA:
   The UE performs small data transmission using 2 step RA. Group A is selected.
Else If the message size (UL data available for transmission plus MAC header and, where required, MAC control elements) is greater than TB size of MsgA payload according to MsgA-PUSCH-Config-SDT-groupA and (‘is greater than TB size of MsgA payload according to MsgA-PUSCH-Config-SDT-groupA and’ can be removed in one embodiment) is less than equal to the TB size of MsgA payload according to MsgA-PUSCH-Config-SDT-groupB for the selected UL carrier and RSRP of the downlink pathloss reference is greater than or equal to sdt-Threshold-MsgA-groupB:
   The UE performs small data transmission using 2 step RA. Group B is selected.
Else:
The UE initiates 2 step RA for resuming connection (small data is not included).

This option can be generalized wherein gNB configures the parameters MsgA-PUSCH-Config-SDT-group1 to MsgA-PUSCH-Config-SDT-groupN, sdt-Threshold-MsgA-group1 to sdt-Threshold-MsgA-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for random access procedure and RSRP of the downlink pathloss reference is greater than or equal to sdt-Threshold-MsgA-group1:
   The UE performs small data transmission using 2 step RA. Group 1 is selected.
Else If the message size (UL data available for transmission plus MAC header and, where required, MAC control elements) is greater than TB size of MsgA payload according to MsgA-PUSCH-Config-SDT-group1 and (‘is greater than TB size of MsgA payload according to MsgA-PUSCH-Config-SDT-group1 and’ can be removed in one embodiment) is less than equal to the TB size of MsgA payload according to MsgA-PUSCH-Config-SDT-group2 for SDT on UL carrier selected for random access procedure and RSRP of the downlink pathloss reference is greater than or equal to sdt-Threshold-MsgA-group2:
   The UE performs small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (‘is greater than TB size of MsgA payload according to MsgA-PUSCH-Config-SDT-group2 and’ can be removed in one embodiment) is less than equal to the TB size of MsgA payload according to MsgA-PUSCH-Config-SDT-group3 for SDT on UL carrier selected for random access procedure and RSRP of the downlink pathloss reference is greater than or equal to sdt-Threshold-MsgA-group3:
   The UE performs small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN-1 and (‘is greater than TB size of MsgA payload according to MsgA-PUSCH-Config-SDT-groupN-1 and’ can be removed in one embodiment) is less than equal to the TB size of MsgA payload according to MsgA-PUSCH-Config-SDT-groupN for SDT on UL carrier selected for random access procedure and RSRP of the downlink pathloss reference is greater than or equal to sdt-Threshold-MsgA-groupN:
   The UE performs small data transmission using 2 step RA. Group N is selected.
Else:
   The UE initiates 2 step RA for resuming connection (small data is not included).
Option 8-4: Single MsgA PUSCH configuration, single msgA-messagePowerOffsetSDT for pathloss threshold

The gNB configures a single MsgA-PUSCH-Config-SDT (i.e., a PUSCH resource pool) in 2 step RA configuration for SDT. The TBS is not explicitly signaled but determined based on SCS, number of PRBs and number of OFDM symbols of PO. gNB also configures the parameter msgA-messagePowerOffsetSDT. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA PUSCH configuration for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffsetSDT:
   The UE initiates 2 step RA for small data transmission.
Else:
   The UE initiates 2 step RA for resuming connection (small data is not included).
Option 8-5: Multiple [MsgA PUSCH configuration, msgA-messagePowerOffsetSDT, preamble group]

The gNB configures the parameter MsgA-PUSCH-Config-SDT-groupA and MsgA-PUSCH-Config-SDT-in 2 step RA configuration for SDT. The TBS is not explicitly signaled but determined based on SCS, number of PRBs and number of OFDM symbols of PO. msgA-messagePowerOffset-groupB is also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for random access procedure:
   The UE performs small data transmission using 2 step RA. Group A is selected.
Else If the message size (UL data available for transmission plus MAC header and, where required, MAC control elements) is greater than TB size of MsgA payload according to MsgA-PUSCH-Config-SDT-groupA and (‘is greater than TB size of MsgA payload according to MsgA-PUSCH-Config-SDT-groupA and’ can be removed in one embodiment) is less than equal to the TB size of MsgA payload according to MsgA-PUSCH-Config-SDT-groupB for the selected UL carrier and the pathloss is less than PCMAX (of the Serving Cell performing the Random Access Procedure)−msgA-preambleReceivedTargetPower−msgA-DeltaPreamble−msgA-messagePowerOffset-groupB:
   The UE performs small data transmission using 2 step RA. Group B is selected.
Else:
   The UE initiates 2 step RA for resuming connection (small data is not included).

This option can be generalized wherein gNB configures the parameters MsgA-PUSCH-Config-SDT-group1 to MsgA-PUSCH-Config-SDT-groupN, msgA-messagePowerOffset-group2 to msgA-messagePowerOffset-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for random access procedure:
   The UE performs small data transmission using 2 step RA. Group 1 is selected.
Else If the message size (UL data available for transmission plus MAC header and, where required, MAC control elements) is greater than TB size of MsgA payload according to MsgA-PUSCH-Config-SDT-group1 and (‘is greater than TB size of MsgA payload according to MsgA-PUSCH-Config-SDT-group1 and’ can be removed in one embodiment) is less than equal to the TB size of MsgA payload according to MsgA-PUSCH-Config-SDT-group2 for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-group2:
   The UE performs small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (‘is greater than TB size of MsgA payload according to MsgA-PUSCH-Config-SDT-group1 and’ can be removed in one embodiment) is less than equal to the TB size of MsgA payload according to MsgA-PUSCH-Config-SDT-group3 for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-group2:
   The UE performs small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN-1 and (‘is greater than TB size of MsgA payload according to MsgA-PUSCH-Config-SDT-groupN-1 and’ can be removed in one embodiment) is less than equal to the TB size of MsgA payload according to MsgA-PUSCH-Config-SDT-groupN for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-groupN:
   The UE performs small data transmission using 2 step RA. Group N is selected.
Else:
   The UE initiates 2 step RA for resuming connection (small data is not included).
Option 8-5A:

The gNB configures the parameter MsgA-PUSCH-Config-SDT-groupA and MsgA-PUSCH-Config-SDT-in 2 step RA configuration for SDT. The TBS is not explicitly signaled but determined based on SCS, number of PRBs and number of OFDM symbols of PO. msgA-messagePowerOffset-groupB and msgA-messagePowerOffset-groupA is also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-groupA:
   The UE performs small data transmission using 2 step RA. Group A is selected.
Else If the message size (UL data available for transmission plus MAC header and, where required, MAC control elements) is greater than TB size of MsgA payload according to MsgA-PUSCH-Config-SDT-groupA and (‘is greater than TB size of MsgA payload according to MsgA-PUSCH-Config-SDT-groupA and’ can be removed in one embodiment) is less than equal to the TB size of MsgA payload according to MsgA-PUSCH-Config-SDT-groupB for the selected UL carrier and the pathloss is less than PCMAX (of the Serving Cell performing the Random Access Procedure)−msgA-preambleReceivedTargetPower−msgA-DeltaPreamble−msgA-messagePowerOffset-groupB:
   The UE performs small data transmission using 2 step RA. Group B is selected.
Else:
   The UE initiates 2 step RA for resuming connection (small data is not included).

This option can be generalized wherein gNB configures the parameters MsgA-PUSCH-Config-SDT-group1 to MsgA-PUSCH-Config-SDT-groupN, msgA-messagePowerOffset-group1 to msgA-messagePowerOffset-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-group1:
   The UE performs small data transmission using 2 step RA. Group 1 is selected.
Else If the message size (UL data available for transmission plus MAC header and, where required, MAC control elements) is greater than TB size of MsgA payload according to MsgA-PUSCH-Config-SDT-group1 and (‘is greater than TB size of MsgA payload according to MsgA-PUSCH-Config-SDT-group1 and’ can be removed in one embodiment) is less than equal to the TB size of MsgA payload according to MsgA-PUSCH-Config-SDT-group2 for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-group2:
   The UE performs small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (‘is greater than TB size of MsgA payload according to MsgA-PUSCH-Config-SDT-group2 and’ can be removed in one embodiment) is less than equal to the TB size of MsgA payload according to MsgA-PUSCH-Config-SDT-group3 for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-group2:
   The UE performs small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN-1 and (‘is greater than TB size of MsgA payload according to MsgA-PUSCH-Config-SDT-groupN-1 and’ can be removed in one embodiment) is less than equal to the TB size of MsgA payload according to MsgA-PUSCH-Config-SDT-groupN for SDT on UL carrier selected for random access procedure and the pathloss is less than PCMAX (of the Serving Cell performing the Random Access Procedure)−msgA-preambleReceivedTargetPower−msgA-DeltaPreamble−msgA-messagePowerOffset-groupN:
   The UE performs small data transmission using 2 step RA. Group N is selected.
Else:
   The UE initiates 2 step RA for resuming connection (small data is not included).
Option 8-6: Multiple [TBS, preamble group]

The gNB configures the parameter MsgA-PUSCH-Config-SDT-groupA and MsgA-PUSCH-Config-SDT-in 2 step RA configuration for SDT. The TBS is not explicitly signaled but determined based on SCS, number of PRBs and number of OFDM symbols of PO. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA:
   The UE performs small data transmission using 2 step RA. Group A is selected.
Else If the message size (UL data available for transmission plus MAC header and, where required, MAC control elements) is less than equal to the TB size TB size of MsgA payload according to MsgA-PUSCH-Config-SDT-groupB
   The UE performs small data transmission using 2 step RA. Group B is selected.
Else:
   The UE initiates 4 step RA for resuming connection (small data is not included).

This option can be generalized wherein gNB configures the parameters MsgA-PUSCH-Config-SDT-group1 and MsgA-PUSCH-Config-SDT-groupN, preambles for group 1 to N.
If the message size (UL data available for transmission plus MAC header and, where required, MAC control elements) is less than equal to the TB size of MsgA payload according to MsgA-PUSCH-Config-SDT-group1:
   The UE performs small data transmission using 4 step RA. Group 1 is selected.
Else, if the message size (UL data available for transmission plus MAC header and, where required, MAC control elements) is less than equal to the TB size of MsgA payload according to MsgA-PUSCH-Config-SDT-group2:
   The UE performs small data transmission using 2 step RA. Group 2 is selected.
Else If the message size (UL data available for transmission plus MAC header and, where required, MAC control elements) is less than equal to the TB size of MsgA payload according to MsgA-PUSCH-Config-SDT-group3:
   The UE performs small data transmission using 2 step RA. Group 3 is selected.
Else If the message size (UL data available for transmission plus MAC header and, where required, MAC control elements) is less than equal to the TB size of MsgA payload according to MsgA-PUSCH-Config-SDT-groupN:
   The UE performs small data transmission using 4 step RA. Group N is selected.
Else:
   The UE initiates 4 step RA for resuming connection (small data is not included).

Note: separate msgA-DeltaPreamble could be configured per TBS in the above procedure.

### Embodiment 3-4—Criteria to Determine Whether to Use Preconfigured PUSCH Resource for SDT or Not

The UE performs SDT using preconfigured PUSCH resource if the following conditions are met. In an embodiment of the disclosure, a subset of the below conditions can be used.
Condition 1: the upper layers request resumption of an RRC connection and the resumption request is for mobile originating calls and the establishment cause is mo-Data.
Condition 2: the UE supports SDT.
Condition 3: Preconfigured PUSCH resources are signaled in RRCRelease message with suspend indication during the preceding suspend procedure and the UE is in same cell from which it has received Preconfigured PUSCH resources.
Condition 4: the UE has a stored value of the nextHopChainingCount provided in the RRCRelease message with suspend indication during the preceding suspend procedure, In an embodiment of the disclosure, this condition may not be used e.g., if the UE's current serving cell/gNB is same as the serving cell (SpCell)/gNB at the time of last connection release.
Condition 5: If the LCH restrictions for LCP are applied for SDT and all LCHs for which data is available for transmission is allowed to be multiplexed in MAC PDU for Preconfigured PUSCH resource for SDT according to LCH restrictions.

Network can also indicate the DRBs for which SDT is allowed. In this case, LCHs corresponding to the DRBs for which SDT is allowed is considered. If data is available for transmission for DRBs other than DRBs for which SDT is allowed, the UE shall initiate connection resume without SDT.

In an embodiment condition 5 is not used for determining SDT or not.
Condition 6: the UE has a valid TA value.

Network configures SDT-TimeAlignmentTimer. The SDT-TimeAlignmentTimer is started upon receiving the SDT-TimeAlignmentTimer configuration from network. When a Timing Advance Command MAC control element is received or PDCCH indicates timing advance adjustment, the SDT-TimeAlignmentTimer is restarted.
If SDT-TimeAlignmentTimer is running, and
If the SS-RSRP of pathloss reference has not increased by more than rsrp-IncreaseThresh since the last time SDT-TimeAlignmentTimer was started, and
If the SS-RSRP of the pathloss reference has not decreased by more than rsrp-DecreaseThresh since the last time SDT-TimeAlignmentTimer was started:
   TA is considered valid.
Condition 7: the UE has at least one SSB with SS-RSRP above a threshold, amongst the SSBs associated with Preconfigured PUSCH resources for UL carrier selected for SDT using Preconfigured PUSCH resources. If the RSRP of the downlink pathloss reference is less than rsrp-ThresholdSSB-SUL, SUL is selected for SDT using Preconfigured PUSCH resources. Otherwise, NUL is selected for SDT using Preconfigured PUSCH resources. In an embodiment condition 7 is not used for determining SDT or not.
Condition 8: If the size of MAC PDU to be transmitted is <=TBS of Preconfigured PUSCH resource. Note that multiple TBS size and criteria to select can be same as defined in 2 step RA

### Embodiment 4—RRC Less Small Data Transmission

RRCResumeRequest/RRCResumeRequest1 is transmitted by the UE along with UL data in Msg3/MsgA of 4 step/2 step RACH based small data transmission respectively.

RRC message includes:
full/short I-RNTI (resumeIdentity),
the resume cause (resumeCause),
an authentication token (resumeMAC-I).
   K_{RRCint} from the stored AS security context is used to generate resumeMAC-I along with other parameters (i.e., BEARER set to 1, DIRECTION set to 1, COUNT set to 1, source PCI, target Cell-ID and source C-RNTI).

Here, what is the content of MsgA/Msg3 in case of RRC-less, i.e., without RRC message, and what does trigger condition for using RRC-less will be described.

### Embodiment 4-1—RRC-Less Approach for RACH Based Small Data Transmission

UL data is included in MsgA/Msg3.

Upon receiving MsgA/Msg3, gNB needs to identify the UE which has transmitted MsgA/Msg3. For the UE identification one of the following information is included in MsgA/Msg3.
Option 9-1-1: C-RNTI (C-RNTI used by the UE during the last RRC connection),
Option 9-1-2: Full I-RNTI (e.g., complete 40 bit I-RNTI)
Option 9-1-3: Short I-RNTI (e.g., 24 bits of I-RNTI)
The UE ID to be used can be pre-defined in spec, or network (i.e., the gNB) can indicate (in SI or RRC message) which one of the above IDs are included in MsgA/Msg3
The UE ID is included in MAC CE.

Upon receiving MsgA/Msg3, gNB should be able to authenticate the UE which has transmitted UL data in MsgA/Msg3. For authentication one of the following is included.
Option 9-2-1: Generate MAC-I over UL data
   MAC CE including the UE ID+MAC SDU(s) including integrity protected UL data is transmitted in MsgA/Msg3. Integrity protected UL data means MAC SDU includes UL data and MAC-I where MAC-I is generated over UL data.
Option 9-2-2: Generate resumeMAC-I,
   MAC CE including the UE ID and resumeMAC-I+MAC SDU(s) including UL data is transmitted in MsgA/Msg3
Option 9-2-3: Generate MAC-I over UL data if integrity protection is enabled for DRB whose UL data is included in MsgA/Msg3. Otherwise generate resumeMAC-I.
   MAC CE will include the UE ID or the UE ID+resumeMAC-I
Option 9-2-4: Authentication only if integrity protection for SDT DRBs (i.e., DRBs for which SDT is allowed) is enabled.
   MAC CE including the UE ID+MAC SDU(s) including UL data is transmitted in MsgA/Msg3. UL data may or may not be integrity protected depending on whether IP is enabled or not for the corresponding DRB.

Contention resolution
Contention resolution identity needs to be modified (currently it is 48 bits of CCCH SDU). In the absence of RRC message Contention resolution identity needs to be set to the UE ID transmitted by the UE in MsgA/Msg3.
Alternately if C-RNTI is included in MsgA/Msg3, PDCCH addressed to C-RNTI can be used for contention resolution,

Security key (This is applicable to both RRC-less or RRC based SDT, Scenario is that the UE is performing SDT in same serving cell as the serving cell in which the UE entered inactive),
Should the UE uses security key in stored AS context for data protection or generate new key using NCC?
   If security key in stored AS context is used, security parameters (BEARER, DIRECTION, COUNT) will be same for packet transmitted when RRC connected and packet transmitted for SDT. Security principle is to not repeat the same set of parameters for more than one packet. So security key should be generated using NCC. To avoid security issue, the UE re-initialize the PDCP state variable TX_NEXT to the value at the time of entering inactive, RX_NEXT and RX_DELIV can be set according to first received packet during SDT.

### Embodiment 4-2—RRC-Less Approach for CG Based Small Data Transmission

UL data is included in CG

The gNB can identify the UE based on CG in which UL data is received. CG is UE specific. So no need to include the UE ID along with UL data.

Upon receiving UL data in CG, gNB should be able to authenticate the UE which has transmitted UL data. For authentication one of the following can be considered.
Option 9-3-1: Generate MAC-I over UL data
   MAC SDU(s) including integrity protected UL data is transmitted in CG. No MAC CE.
Option 9-3-2: Generate resumeMAC-I,
   MAC CE including resumeMAC-I+MAC SDU(s) including UL data is transmitted in CG,
Option 9-3-3: Generate MAC-I over UL data if integrity protection is enabled for DRB whose UL data is included in CG. Otherwise generate resumeMAC-I.
Option 9-3-4: Authentication only if integrity protection for DRBs is enabled.
   MAC SDU(s) including UL data is transmitted in CG. UL data may or may not be integrity protected depending on whether IP is enabled or not for the corresponding DRB.

### Embodiment 4-3—Trigger Condition for Selecting Between RRC Based and RRC Less Approach for Small Data Transmission

Option 9-4-1: the UE uses RRC-less if the UE's current serving cell is same as the PCell where the UE was connected to prior to suspension of the RRC connection.
Option 9-4-2: the UE uses RRC-less if the UE's current serving cell belongs to the same gNB as the gNB of the PCell where the UE was connected to prior to suspension of the RRC connection.
Option 9-4-3: the UE uses RRC-less if the UE's current serving cell is same as the PCell where the UE was connected to prior to suspension of the RRC connection and integrity protection is enabled for the DRB which triggered small data transmission.
Option 9-4-4: the UE uses RRC-less if the UE's current serving cell belongs to the same gNB as the gNB of the PCell where the UE was connected to prior to suspension of the RRC connection and integrity protection is enabled for the DRB which triggered small data transmission.
Option 9-4-5: If CG is used for small data transmission, use RRC less otherwise RRC based.

In each of option 9-4-1 to option 9-4-5, addition condition, i.e., if network supports RRC-less can be included. Whether network supports can be signaled in system information.

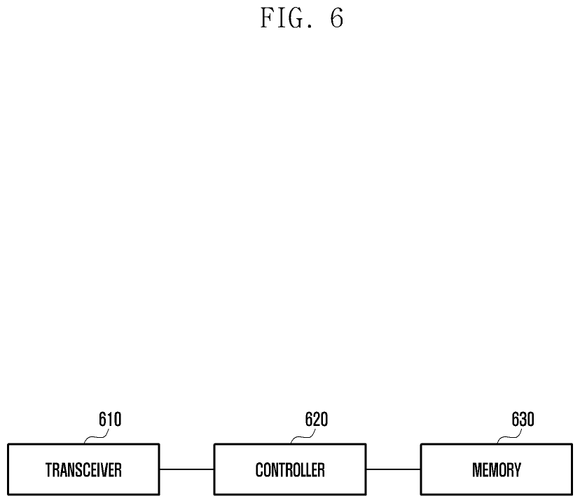

FIG. 6 is a block diagram of a terminal according to an embodiment of the disclosure.

Referring to FIG. 6, a terminal includes a transceiver 610, a controller 620 and a memory 630. The controller 620 may refer to a circuitry, an application-specific integrated circuit (ASIC), or at least one processor. The transceiver 610, the controller 620 and the memory 630 are configured to perform the operations of the terminal illustrated in the FIGS. 1 to 5, or described above. Although the transceiver 610, the controller 620 and the memory 630 are shown as separate entities, they may be realized as a single entity like a single chip. Or, the transceiver 610, the controller 620 and the memory 630 may be electrically connected to or coupled with each other.

The transceiver 610 may transmit and receive signals to and from other network entities, e.g., a base station.

The controller 620 may control the terminal to perform functions according to one of the embodiments described above. For example, the controller 620 controls the transceiver 610 and/or memory 630 to perform small data transmission and reception according to various embodiments of the disclosure.

In an embodiment of the disclosure, the operations of the terminal may be implemented using the memory 630 storing corresponding program codes. Specifically, the terminal may be equipped with the memory 630 to store program codes implementing desired operations. To perform the desired operations, the controller 620 may read and execute the program codes stored in the memory 630 by using at least one processor or a CPU.

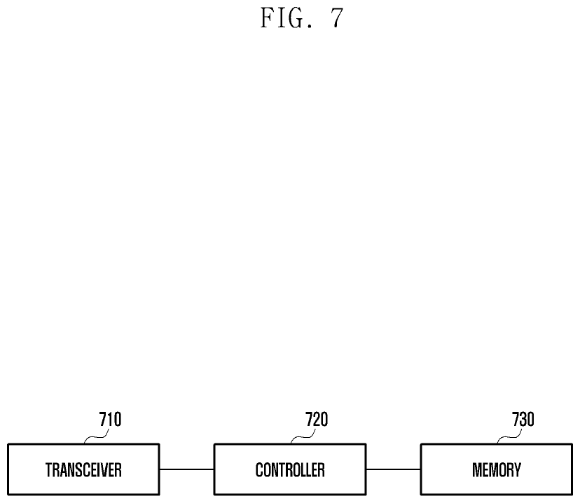

FIG. 7 is a block diagram of a base station according to an embodiment of the disclosure.

Referring to FIG. 7, a base station includes a transceiver 710, a controller 720 and a memory 730. The controller 720 may refer to a circuitry, an ASIC, or at least one processor. The transceiver 710, the controller 720 and the memory 730 are configured to perform the operations of the UE illustrated in the FIGS. 1 to 5, or described above. Although the transceiver 710, the controller 720 and the memory 730 are shown as separate entities, they may be realized as a single entity like a single chip. Or, the transceiver 710, the controller 720 and the memory 730 may be electrically connected to or coupled with each other.

The transceiver 710 may transmit and receive signals to and from other network entities, e.g., a terminal or a UE.

The controller 720 may control the base station to perform functions according to one of the embodiments described above. For example, the controller 720 controls the transceiver 710 and/or memory 730 to perform small data transmission and reception according to various embodiments of the disclosure.

In an embodiment of the disclosure, the operations of the base station may be implemented using the memory 730 storing corresponding program codes. Specifically, the base station may be equipped with the memory 730 to store program codes implementing desired operations. To perform the desired operations, the controller 720 may read and execute the program codes stored in the memory 730 by using at least one processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
measuring a synchronization signal-reference signal received power (SS-RSRP) of a synchronization signal block (SSB) while a small data transmission (SDT) procedure is ongoing, the SDT procedure being initiated by a first random access (RA) procedure;
identifying whether the measured SS-RSRP of the SSB is less than a threshold value; and
initiating a second RA procedure in case that the measured SS-RSRP of the SSB is less than the threshold value.

2. The method of claim 1, wherein the SS-RSRP of the SSB is measured after the completion of the first RA procedure.

3. The method of claim 1, wherein the SSB is selected during a last completed random access procedure or during the SDT procedure initiated by the first RA procedure.

4. The method of claim 1, wherein the initiating further comprising:
receiving a system information block (SIB) including configuration information including an ra-searchspace;
identifying whether the configuration information includes an sdt-searchspace; and
initiating the second RA procedure for an SDT, wherein the second RA procedure for the SDT is either a 4-step RA procedure or a 2-step RA procedure.

5. The method of claim 4, further comprising:
based on a completion of the second RA procedure, monitoring a physical downlink control channel (PDCCH) addressed to a cell-radio network temporary identifier (RNTI) (C-RNTI) in the sdt-searchspace, for a downlink reception or an uplink transmission until the SDT is terminated, in case that the sdt-searchspace is included in the configuration information; and
monitoring a PDCCH in the ra-searchspace, for the downlink reception or the uplink transmission, in case that the sdt-searchspace is not included in the configuration information.

6. The method of claim 4, further comprising:
receiving a contention resolution identity; and
identifying a contention resolution based on the contention resolution identity being received,
wherein the second RA procedure is completed based on the contention resolution.

7. A terminal in a wireless communication system, the terminal comprising:
a transceiver; and
at least one processor configured to:
measure a synchronization signal-reference signal received power (SS-RSRP) of a synchronization signal block (SSB) while a small data transmission (SDT) procedure is ongoing, the SDT procedure being initiated by a first random access (RA) procedure,
identify whether the measured SS-RSRP of the SSB is less than a threshold value, and
initiate a second RA procedure in case that the measured SS-RSRP of the SSB is less than the threshold value.

8. The terminal of claim 7, wherein the SS-RSRP of the SSB is measured after the completion of the first RA procedure.

9. The terminal of claim 7, wherein the SSB is selected during a last completed random access procedure or during the SDT procedure initiated by the first RA procedure.

10. The terminal of claim 7, wherein the at least one processor is further configured to:
receive, via the transceiver, a system information block (SIB) including configuration information including an ra-searchspace;
identify whether the configuration information includes an sdt-searchspace; and
initiate the second RA procedure for an SDT, wherein the second RA procedure for the SDT is either a 4-step RA procedure or a 2-step RA procedure.

11. The terminal of claim 10, wherein the at least one processor is further configured to:
based on a completion of the second RA procedure, monitor a physical downlink control channel (PDCCH) addressed to a cell-radio network temporary identifier (RNTI) (C-RNTI) in the sdt-searchspace, for a downlink reception or an uplink transmission until the SDT is terminated, in case that the sdt-searchspace is included in the configuration information; and
monitor a PDCCH in the ra-searchspace, for the downlink reception or the uplink transmission, in case that the sdt-searchspace is not included in the configuration information.

12. The terminal of claim 10, wherein the at least one processor is further configured to:
receive, via the transceiver, a contention resolution identity; and
identify a contention resolution based on the contention resolution identity being received,
wherein the second RA procedure is completed based on the contention resolution.
